(19) United States
(12) Patent Application Publication
(10) Pub. No.: US 2004/0134997 A1
(43) Pub. Date: Jul. 15, 2004

(54) Method and apparatus for controlling atmospheric conditions

(76) Inventors: Alexander Khain, Jerusalem (IL); Yuri Feldman, Jerusalem (IL); Mark Pinsky, Jerusalem (IL); Vladimir Arkhipov, Kyriat Yovel (IL); Yaroslav Ryabov, Jerusalem (IL); Alexander Puzenko, Jerusalem (IL)

Correspondence Address: Gary M. Nath, NATH & ASSOCIATES PLLC, 6th Floor, 1030 15th Street, N.W., Washington, DC, 20005, US

(21) Appl. No.: 10/726,563

(22) Filed: Dec. 4, 2003

Related U.S. Application Data
(63) Continuation-in-part of application No. PCT/IL02/01036, filed on Dec. 25, 2002.

(30) Foreign Application Priority Data
Dec. 25, 2001 (IL) 147287

(51) Int. Cl. E01H 13/00

(52) U.S. Cl. 239/14.1

(57) ABSTRACT

A method and system for controlling atmospheric conditions in a portion of the atmosphere for weather modification is described. The control of atmospheric conditions is carried out by controllably urging the collisions between the water droplets in the atmosphere so as to cause their controllable coalescence. The urging is characterized by adjusting non-gravitational attraction forces between the droplets to a predetermined value so as to alter a collision rate between the water droplets to a desired value. The changes of the non-gravitational attraction force between the droplets are achieved by dosed seeding in a portion of a cloud or fog a particulate material that is electrically charged to a required magnitude and polarity. The dosed seeding of the charged materials controls the concentration of the charged droplets and the electric attraction between the charged droplets with neutral droplets as well as the electric interaction between the charged droplets.

### FIELD OF THE INVENTION

This invention relates to a method and apparatus for weather control and modification, and in particular, for controlling atmospheric conditions by seeding dispersing materials in the atmosphere causing the precipitation of water therein.

### BACKGROUND OF THE INVENTION

Various techniques are known in the art for treating atmospheric conditions to precipitate atmospheric water. Such techniques are utilized for the regulation and enhancement of rain, prevention and suppression of hail, dispersal of ground mist and abatement of fog. In particular, the regulation and enhancement of rain is especially important in countries that experience water shortage for agriculture and other human activities, for example, while the modifying of unfavorable weather by precipitation of fog or mist is crucial for increasing visibility, for example, on roads and runways of airports.

It is known that typically water droplets in clouds and fogs are relatively small. Magnitudes of the radii of majority of the droplets in clouds and fogs are distributed in the ranges of 1-10 microns and 1-5 microns, respectively. However, in order to trigger raindrop formation owing to natural process of droplet collision, the droplet radius should exceed 20-25 microns (see, for example, Khain et al, “Notes on the state-of-the-art numerical modeling of cloud microphysics”. Atmos. Res., 2000 v. 55, p. 159-224). Water droplets with a radius of higher than 25 microns have sufficient mass to attain a fall velocity under the force of gravity sufficient to collect smaller droplets and precipitate from clouds or fog owing to their collisions and coalescence. On the other hand, the gravity-induced approach of small droplets does not usually lead to their coalescence, because most of the small droplets move around their counterparts together with the airflow.

It should be noted that droplets having a radius of 1 to 25 microns will be referred to hereafter as “microscopic droplets”, and droplets having a radius exceeding 25 microns will be referred to hereinafter as drops. All references to the size of drops or droplets refer to their radius.

FIG. 1 illustrates a scheme of collisions of small droplets 11 having a radius of r with a large drop 12 (also known as a “drop-collector”) having a radius of R. The drop 12 moving under the force of gravity may collect the small droplets locating within a cylinder 13. A volume of the cylinder 13 over a unit of time reads:

V=π(R+r)²[V_{R}−Vᵣ] (1)

wherein π(R+r) is the area of a geometric cross-section 14; and Vᵣ and V_{R} are the velocities of the droplets 11 and the drop-collector 12, respectively.

A collision rate N (the number of collisions per a unit of time) may be expressed as a product of the volume of the cylinder 13 and the concentration C of the droplets 11, to wit:

N=VC (2)

However, the number of collisions in clouds and fogs is, in fact, much smaller than that determined by Eq. (2), because most of the small droplets move around the drop-collector 12 together with the airflow without collisions. Collisions between the droplets are possible only due to droplet inertia that leads to a deviation of the collected droplets from streamlines 16 of the airflow. Since the inertia of small droplets is small, most of the droplets move around the drop-collector 12, avoiding collisions. Thus, only the droplets located in a swept volume 15 (that is a rather small fraction of the volume of the cylinder 13) experiences collisions. This fraction is referred to as a collision efficiency that can be defined as the ratio between an area S of the collision cross-section 17 and the area of the geometrical cross-section 14, to wit:

E=S/π(R+r)² (3)

As a result, an effective collision rate N _{eff} can be determined according to the following equation:

N_{eff}=E·V·C (4)

FIG. 2 shows a dependence of the collision efficiency E on the ratio r/R plotted for various radii R of the drop-collector (12 in FIG. 1). It can be appreciated that when the drop collectors have a small radius, i.e. around 10 microns (curve 21), the value of the collision efficiency is very small (ranging from 10⁻⁴ to 10⁻²). In other words, the small droplets, in fact, do not collide over a reasonable period of time.

On the other hand, when the drop-collectors reach a radius exceeding about 20 microns, the collision efficiency E has a value sufficient to produce collisions, i.e. larger than 0.1 (curves 22-24). This drop-collector size is usually thought of as the minimum drop size necessary for triggering a process of collisions and creating the raindrops, i.e., drops larger than about 50 microns in radius.

Therefore, if a cloud does not have a sufficient number of large drop-collectors, it cannot realize fully its precipitation potential. Such a situation in clouds is quite usual, because the time necessary to form large drops in natural conditions often exceeds the time period of the cloud's development.

Various techniques have been used to date to accelerate the droplet collisions sufficient for the generation of cloud and fog droplets.

One of the methods of treatment of atmospheric conditions for this purpose is the glaciogenic seeding technique, i.e. artificially creating ice freezing nuclei and generating ice crystals in supercooled clouds and fogs (see for example, U.S. Pat. No. 3,429,507 to Jones; U.S. Pat. No. 3,613,992 to Knollenberg; U.S. Pat. No. 3,788,543 to Amand et al; U.S. Pat. No. 4,096,005 to Slusher; U.S. Pat. No. 5,174,498 to Popovitz-Ronit et al; U.S. Pat. No. 5,360,162 to Mentus, and U.S. Pat. No. 6,056,203 to Fukuta. One of the main drawbacks of the prior art glaciogenic seeding methods is their limited operability, since they may be utilized only when cloud or fog water droplets are below the freezing point of water (around 0° C.).

Various techniques for promoting the precipitation of cloud and fog droplets at temperatures above the freezing point of water are also known in the art. These techniques are based on dispersing the particles having the property of absorbing the water from clouds and fog, thereby creating large droplet-collectors.

One such technique for triggering raindrop formation through the acceleration of large droplets formation is the hygroscopic seeding technique. This technique is widely utilized for rain enhancement and fog dispersal (see, for example, G.B. Pat. No 1,110,768; U.S. Pat. No. 3,378,201 to Glew et al; U.S. Pat. No. 3,608,810 to Kooser; U.S. Pat. No. 3,608,820 to Kooser; U.S. Pat. No. 3,659,785 to Nelson; U.S. Pat. No. 3,802,624 to Kuhne; U.S. Pat. No. 3,896,993 to Serpolay; U.S. Pat. No. 3,940,059 to Clark; U.S. Pat. No. 4,362,271 to Montmory; U.S. Pat. No. 4,653,690 to St. Amand et al.; and U.S. Pat. No. 5,357,865 to Mather). The main idea of the hygroscopic seeding, widely employed our days for weather modification purposes, is to increase the rate of droplet collisions by an increase in the concentration (or creation) of large droplets in the droplet size distributions (DSD). According to this technique, clouds are usually seeded by soluble particles, which play the role of cloud condensational nuclei (CCN). It is assumed that the spectrum of seed particles contains large CCN. The droplets grown on these CCN are larger than natural droplets and attain the size needed for the collision triggering earlier (and at lower levels) than the other droplets.

The prior art hygroscopic seeding techniques suffer from numerous drawbacks. For example, when granular materials are used as seed agents, their hygroscopic nature often causes agglomeration and caking in storage, even in the presence of low moisture content. These negative phenomena lead to the creation of particles of sizes which are usually much greater than the desired value, that is, e.g., about 1 to 10 microns in radius. Notwithstanding that huge hygroscopic particles could be appropriate for the creation of large drop-collectors, such particles are rather heavy for transportation by airplanes to provide the desirable concentration of such particles into clouds. Thus, the utilization of such materials turns out to be inefficient.

Another example of hygroscopic materials widely used for cloud seeding is particles obtained by burning (flares) (see, for example, Mather, et al., “Results of the South African Cloud-Seeding Experiments Using Hygroscopic Flares,” Journal of Applied Meteorology: 1997, V. 36, No. 11, pp. 1433-1447). However, these materials contain mainly small particles (less than 1 micron in radius), leading to the growth of small droplets, which are ineffective for precipitation. In other words, the fraction of the large particles (effective for the purpose of creating drop-collectors) in the flares is remarkably lower than that of the small particles. Since the effects of the small and large particles on the drop growth are opposite, the total effect of the seeding is not clear (see, for example, R. T. Bruintjes, “A review of cloud seeding experiments to enhance precipitation and some new prospects”, Bull. Amer. Met. Soc., 1999, V. 80, P. 805-819).

Also known in the art are electrostatic precipitation techniques employing an electrical field to force liquid particles in the fog together to form large drops of sufficient mass to precipitate. U.S. Pat. No. 1,928,963 to Chaffee describes a technique for dissolving clouds and fogs and producing rain by scattering charged particles in the atmosphere. More specifically, it was assumed that when the charges of the moisture particles (i.e., cloud/fog droplets) are all of the same sign, whether positive or negative, these particles are kept apart by repulsion for an indefinite period, until atmospheric disturbances bring about a change in electrical conditions. Thus, it was proposed to seed clouds and fogs by charged particles with a sign opposite to that of the moisture particles to induce collisions between the scattered particles and moisture particles of cloud and fog.

It is relevant to note that besides the pioneering idea of utilizing charged particles for seeding clouds and fog, U.S. Pat. No. 1,928,963 does not provide any practical solution for controlling atmospheric conditions, owing to the fact that at the time when U.S. Pat. No. 1,928,963 was filed and prosecuted (1925-1933) there was no correct scientific understanding of the physical processes occurring in clouds and fog. In particular, U.S. Pat. No. 1,928,963 mistakenly assumes that water droplets always repel when the charges of the droplets are all of the same sign. Likewise, U.S. Pat. No. 1,928,963 underestimates the interaction between neutral and electrically charged droplets, which is very important, since the majority of water droplets is usually neutral in natural clouds and fog. Therefore, the proposal of U.S. Pat. No. 1,928,963 first to charge the neutral cloud or fog with electricity of one polarity by treating the cloud or fog by scattering particles having a charge of one sign, and then treat it with particles of the opposite polarity, is not practical.

Moreover, U.S. Pat. No. 1,928,963 also mistakenly assumes that one charged seeding particle can condense around it 30,000-40,000 moisture particles (droplets), with rapid consequent precipitation. Contrary to this assumption, a modern estimation can show that one seeding particle cloud and/or fog cannot collect such a big number of droplets, because (i) the Coulomb force decays rapidly with the distance between the particle centers; and (ii) the magnitude of the collector charge decreases, due to collisions with oppositely charged moisture particles.

Likewise, U.S. Pat. No. 1,928,963 does not teach to use the basic characteristics of atmospheric conditions, such as concentration, mass and size distribution of the moisture and seeding particles for providing control of the collisions required for droplet precipitation. Therefore, U.S. Pat. No. 1,928,963 cannot provide reliable instructions for the error-free control of atmospheric conditions.

It is established that cloud and/or fog droplets can be charged by different mechanisms, such as ion-diffusion, convection charging, inductive charging, thermo-electric effect, contact potential effect etc. (see, for example, Pruppacher and Klett, “Microphysics of Clouds and Precipitation.” Kluwer Academic Publishers, Dordrecht/Boston/London, 1997, pp. 811-827).

U.S. Pat. No. 3,600,653 to Hall describes a method for reducing fog density by passing the fog between a pair of electrodes. However, this method may be utilized only with equipment emitting artificial fog, since the installation of electrodes above a runway for water precipitation in natural fogs would be highly impractical.

U.S. Pat. No. 4,475,927 to Loos describes a technique for the abatement of fog in a space over an aircraft approach zone and runway. According to this technique, charged droplets of both polarities are introduced in the space by air jets. These positively charged droplets having sufficiently low mobility in order to stay long enough are blown aloft to form a virtual electrode suspended at an appropriate height above the ground. The negatively charged droplets (collector drops) are given high enough mobility for collecting of fog drops in an upward motion in the electric field created between the spaced-apart positively and negatively charged droplets.

U.S. Pat. No. 4,671,805 to Gourdine describes an EGD (electro-gas-dynamic) system deployed in an array and used for the precipitation of fog over airports. The patent discloses a technique for producing a cloud of sub-micron size charged water droplets that are sprayed into the atmosphere for creating a space-charge cloud above a runway extending to a height of a few tens of meters. The cloud has a maximum electric field strength at the ground, and a zero field strength at the top of the cloud. The charged water droplets, in their earthward motion under the electric force, attach themselves to any other particles that may be suspended in the space-charge cloud. Precipitation occurs also as wind transports the spaced-charge cloud.

It should also be mentioned that U.S. Pat. No. 4,671,805 observes that seeding fog with electrically charged particles from an airplane was contemplated but discarded in favor a ground-based system owing to the many operational difficulties of an airborne system. The patent does not expand on the nature of these operational difficulties, but in any event, is restricted to a discussion of ground based systems for fog precipitation principally for dispersing fogs near airports and the like. Moreover, no suggestion is made as to how this can be achieved controllably.

One of the main drawbacks of the electrostatic precipitation prior art techniques is their inefficiency, since these techniques require high energy consumption for producing an electromagnetic field over a large space or territory. Therefore, these techniques cannot be utilized over large areas of fog and clouds.

U.S. Pat. No. 4,684,063 to Goudy, Jr. describes a mixer/charger apparatus for a variety of purposes employed simultaneously to mix and to electrically charge a fluid flowing therethrough. In one version, the mixer/charger apparatus includes a liquid supply from which the charged mist ultimately is produced for seeding clouds. In an alternate version, the apparatus employs an air input supply that is delivered to a mixer/charger that produces a charged air output used to effect seeding function.

The techniques mentioned above are addressed to seeding clouds and fog for rain enhancement and/or fog abatement. However, as mentioned above, uncontrolled seeding may result in phenomena that are opposite from what the users expected. For example, the utilization of many conventional glaciogenic and hygroscopic techniques may result in the production of small droplets that are ineffective for rain formation.

The phenomena occurring when the droplets are charged have also been studied in relation to aerosol scavenging and atmospheric cleaning. For example, Grover and Beard in the article entitled “A numerical determination of the efficiency with which electrically charged cloud drops and small raindrops collide with electrically charged spherical particles of various densities,” published in J. Atmos. Sci., 1975, V.32, PP. 2156-2165, calculated the collision efficiencies for droplets having radii ranged between 42 and 142 micrometers, colliding with the small particles of the radii ranged between 0.4 and 4 micrometers. The calculations were conducted both for cases when the droplets and particles were assumed to be conducting spheres, and for cases when the charges were assumed to be in the centers of non-conducting spheres. In particular, a significant increase was found in collision efficiency for the case when the droplets were loaded with the charges having the magnitudes typical for thunderstorm clouds (i.e. larger than 7×10⁴ elementary (electron) charges), while the small particles were charged with the charges of opposite polarity.

Wang, et al. in the article entitled “On the effects of electric charge on the scavenging of aerosol particles by clouds and small raindrops,” published in J. Atmos. Sci., 1978, V. 35, PP. 1735-1743, conducted a set of calculations of the collision efficiency between charged aerosol particles and droplets, assuming that a) the colliding particles have the opposite polarity; and b) the attraction between the colliding particles arises due to the attraction of point charges located in the particle centers. In the calculations, the charges of the colliding particles and droplets were assumed to be proportional to the square of their radii, so that the entire droplet charge was always much greater than the particle charge. The general conclusion drawn from these calculations was that out of the regions of the thunderstorm processes, the effect of electrical forces on particle-droplet collision efficiency for natural clouds is rather weak. It should be noted that the above result was obtained by Wang, et al., for the relatively low charge values of the aerosol particles and in neglecting the image charge forces (induced charges).

Tinsley, et al. in the article entitled “Effects of image charges on the scavenging of aerosol particles by cloud droplets and on droplet charging and possible ice nucleation processes,” published in J. Atmos. Sci., 2000 V. 57, PP. 2118-2134, studied the effects of charge magnitudes on the efficiency of the collisions between droplets and aerosol particles. The calculations were carried out under the assumption that the charged aerosol particles are considered as point charges. It was found that the electrical effects considerably increase the scavenging rate of the small charged aerosol particles having the radii in the range of 0.1 to 1.0 micrometers, even for non-thunderstorm clouds. One of the drawbacks of the calculation method described by Tinsley, et al. is that the effect of the mutual polarization of interacting particles is not taken into account.

### SUMMARY OF THE INVENTION

Despite the extensive prior art in the area of treating atmospheric conditions by seeding various materials, there is still a need for further improvements for controlling the precipitation of atmospheric water.

The present invention satisfies the aforementioned need by providing a novel method of controlling atmospheric conditions in a portion of the atmosphere for weather modification. The portion of the atmosphere may, for example, be a portion of a cloud or fog containing water droplets having different sizes dispersed therein. The droplet size is usually distributed in a broad spectrum of sizes.

The control of atmospheric conditions is carried out by controllably urging the collisions between the water droplets in the atmosphere so as to cause their controllable coalescence. This urging is characterized by adjusting non-gravitational attraction forces between the droplets to a predetermined value so as to alter a collision rate between the water droplets to a desired value.

The changes of the non-gravitational attraction forces between the droplets are achieved by dosed seeding a material in a portion of a cloud or fog that is electrically charged to a required magnitude and polarity. The required magnitude and polarity of the elements of the seeding material depend on (i) a size distribution of the droplets in the portion of the atmosphere, and on (ii) an element size distribution of the seeding material.

According to one embodiment of the invention, the seeding material contains fine particles of a particulate material having a predetermined particle size distribution.

According to another embodiment of the invention, the seeding material contains seeding water droplets. According to one example, the seeding water droplets are collected from the cloud or fog, and then electrically charged to a predetermined magnitude and polarity. According to another example, the seeding water droplets having a predetermined size (or droplet size distribution) are generated by a droplet generating device, e.g., an ultrasonic fog generator.

According to yet embodiment of the invention, the seeding material contains particles of a particulate material together with seeding water droplets. The ratio between a concentration of the particles and the concentration of the water droplets has a predetermined value.

The required charge magnitude and polarity of the seeding elements (particles and/or droplets) are determined by utilizing an appropriate droplet collision model. The droplet collision model takes into account the size distribution of the droplets in the portion of the atmosphere, and the size distribution of the seeding elements. Accordingly, the size distribution of the droplets in the portion of the atmosphere (a cloud or fog) utilized in the model should be determined in advance.

The dosed seeding of the charged seeding materials can control the concentration of the charged droplets in the cloud or fog as well as their charge magnitudes, and thereby can tune the non-gravitational (i.e., electric) interaction between the droplets. The charged seeding elements may, for example, be obtained by passing a particulate material and/or water droplets through an electric discharge, and/or by bringing the seeding material into contact with charged electrodes.

It should be noted that the droplets in natural clouds and fogs are usually electrically neutral and represent weak salt solutions. The electric interaction can take place both between charged droplets themselves as well as between the charged droplets and neutral droplets. When an element of the charged seeding materials approaches an electrically neutral droplet at a distance sufficient for electrical interaction, a charge with a polarity opposite to the charge of the element is induced on the side of the droplet facing the element. The induced charge causes an electrical attraction between the element and droplet, i.e. a non-gravitational attraction. This attraction results in a close approach and capture of the element by the droplet. The droplet that received the charge from the element can, in turn, attract another electrically neutral droplet with a consequent approach and coalescence that would not be possible in the case of a pure gravity-induced attraction. The attractions increase the collision efficiency between the droplets and the rate of their collisions, which in turn fosters the formation of large droplets leading to raindrops in clouds. In case of fog, it leads to the elimination of small droplets owing to their collisions and coalescence that results in fog dissipation.

The foregoing need is also accomplished by providing an apparatus for controlling atmospheric conditions in a portion of the atmosphere containing microscopic water droplets. According to one example, the apparatus includes a portion for controllably producing either positively or negatively charged seeding elements. According to another example, the apparatus includes two substantially identical apparatus portions for controllably producing positively and negatively charged seeding elements, respectively.

The apparatus further includes a power source for providing electric power required for operation of the apparatus, and a control module for controlling the operation of the apparatus. The controllable producing implies providing required concentration of charged elements of each polarity. It should be noted that the concentration and charge value of the positively charged elements may be equal to or different from the concentration and charge value of the negatively charged elements. According to the invention, the optimal values of the concentration and the charge of the seeding elements are calculated as described above by using a collision model describing collisions between the charged seeding elements and the atmospheric water droplets.

Each of the portions for producing positive and negative charged elements includes a chamber for providing an element flow stream of uncharged seeding elements, a charger coupled to the chamber for charging the elements in the element flow stream, and a seeder for controllably scattering the charged seeding elements in the atmosphere.

According to one embodiment of the invention, the chamber of the apparatus includes a feeder of particulate material for allowing the introduction of raw material into the chamber, a mixer for mixing an air flow stream with a particulate material derived from the raw material and an outlet for releasing an output obtained thereby to the charger. The air flow stream can, for example, be provided by a fan coupled to the chamber.

According to another embodiment, the air flow stream is provided by an inlet arranged in the chamber. The inlet is fitted for receiving an input air flow stream containing atmospheric water droplets and transferring this stream to the chamber thereby providing the air flow stream containing atmospheric water droplets. When required, a suction device can be arranged in the inlet for the facilitation of the receiving of the input air flow stream from the atmosphere.

According to yet another embodiment, the apparatus includes a feeder of uncharged water droplets. The feeder includes a tank containing water and a droplet maker, e.g., an ultrasonic mist generator.

In order to control the operation of the apparatus, the control module of the apparatus is equipped with conventional devices for indicating and controlling certain parameters such as the amount and kind of raw material to be used, the strain of the air in the air flow stream, the strain of the element flow stream, the strain of the charged element flow stream, the size, charge and concentration of the seeding elements in the element flow stream, etc.

Accordingly, the control module of the apparatus for each apparatus's portions can include a first strain regulator arranged in the inlet for producing a first sensor signal representative of the strain of the air in the air flow stream. The control module is responsive to the first sensor signal for controlling the strain. The control module can also include a second strain regulator arranged in the outlet for producing a second sensor signal representative of the strain of the element flow stream. The control module is responsive to the second sensor signal for controlling the strain. Further, the module can also include a third strain regulator arranged in the seeder for producing a third sensor signal representative of the strain of the charged element flow stream. The control module is responsive to the third sensor signal for controlling the strain.

The control module can include a charge regulator arranged in the charger and is responsive to a signal produced thereby for controlling the charge magnitude and/or polarity of the charged particles.

When desired, each of the apparatus's portions can also include a burner coupled to the chamber for burning the raw material so as to form the particulate material as a combustion product. In such a case, the control module preferably includes a temperature regulator arranged in the chamber. The temperature regulator is responsive to a signal produced thereby for controlling the temperature in the burner.

The technique of the present invention for controlling the atmospheric conditions has many of the advantages of the aforementioned prior art techniques, while simultaneously overcoming some of the disadvantages normally associated therewith.

Despite the large variety of the prior art techniques dealing with seeding clouds and fog with glaciogenic and hygroscopic materials and also with charged droplets, none of the techniques addresses the controllable seeding of charged particulate materials and charged cloud droplets themselves.

As far as the conventional glaciogenic and hygroscopic seeding techniques are concerned, it is relevant to note that the method of the present invention can provide a significantly higher collision efficiency than the conventional methods used for seeding particulate materials, which lack the step of charging the particles.

Since the electric force is usually larger than the force of hydrodynamic attraction of droplets due to gravity, the charging of particulate seed materials can even provide collisions and forming large drops easily growing to raindrops. These features are impossible in the glaciogenic and hygroscopic seeding techniques. Thus, in contrast to these techniques, not only particles having a size higher than 1 micron can serve as a seed agent, but also even rather small particles of about 0.1 to 1 micron do so. In this case, the competing effects of small and large particles, that crucially decrease the efficiency of the prior art methods of glaciogenic and hygroscopic seeding, are to a large extent eliminated, and both small and large charged particles can participate in the process of large drop formation.

Additionally, according to one embodiment, the raw particulate material utilized for producing charged particles can be selected from a very broad type of conventional materials. Therefore, many inexpensive and easily produced materials (e.g., soot) may be utilized.

Thus, according to one broad aspect of the present invention, there is provided a method of controlling atmospheric conditions in a portion of the atmosphere containing microscopic water droplets dispersed therein so as to produce their desired coalescence and precipitation, the method includes:

(a) determining a size distribution of water droplets in said portion of the atmosphere;

(b) providing a predetermined amount of a seeding material having uncharged seeding elements of a predetermined size distribution;

(c) electrically charging the uncharged seeding elements so as to produce charged seeding elements having a predetermined polarity and charge magnitude, said predetermined polarity and charge magnitude being calculated by using a collision model describing collisions between said charged seeding elements and said microscopic water droplets; and

(d) seeding said charged seeding elements in said portion of the atmosphere

According to another broad aspect of the present invention, there is provided an apparatus for controlling atmospheric conditions in a portion of the atmosphere containing microscopic water droplets dispersed therein, the apparatus comprising:

at least one apparatus portion for controllable producing unipolar charged seeding elements;

a control module for controlling operation of the apparatus; and

an electrical power source for providing electrical power required for operation of the apparatus,

where the apparatus portion for controllable producing unipolar charged seeding elements comprises:

a chamber for providing an element flow stream of a seeding material containing uncharged seeding elements having a predetermined size;

a charger downstream of the chamber and in communication therewith for charging said uncharged seeding elements in said element flow stream so as to produce charged seeding elements having a predetermined polarity and charge magnitude;

a seeder for controllable scattering said charged seeding elements in said portion of the atmosphere

There has thus been outlined, rather broadly, the more important features of the invention in order that the detailed description thereof that follows hereinafter may be better understood. Additional details and advantages of the invention will be set forth in the detailed description, and in part will be appreciated from the description, or may be learned by practice of the invention.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1 illustrates a scheme of collisions of small droplets with a large drop (a drop-collector);

FIG. 2 illustrates an example of the dependence of the collision efficiency on the ratio between the small uncharged droplet and the uncharged drop-collector of FIG. 1, shown for various radii of the drop-collector;

FIG. 3A illustrates an example of the calculation of the dependence of an electric attraction force between a typical droplet and a typical charged particle on the distance therebetween;

FIG. 3B illustrates an example of the calculation of the dependence of an electric attraction force between two differently charged conductive spheres on the distance therebetween;

FIG. 4 illustrates three examples of the dependence of the collision efficiency on the droplet charge for cloud;

FIG. 5 illustrates two examples of the dependence of the collision efficiency on the droplet charge for fog;

FIGS. 6A-6F are schematic block diagrams of various examples of an apparatus, according to the present invention;

FIG. 6B is a schematic block diagram of an apparatus according to another embodiment of the present invention;

FIG. 7 illustrates two examples of the time dependence of visibility in fog seeded by charged seeding elements;

FIG. 8A illustrates four examples of the time dependence of the relative rainwater content in a cloud seeded by charged elements;

FIG. 8B illustrates an example of calculation of evolution of droplet mass distribution in case of uncharged cloud droplets.

FIG. 8C illustrates an example of calculation of evolution of droplet mass distribution in the case when a part of the initial droplets is charged.

FIG. 9 illustrates a three-dimensional plot showing an example of the collision efficiency as the function of radii for two differently charged elements;

FIG. 10 shows a scheme of collisions of small droplets with electrically charged drop-collector;

FIG. 11 shows the results of computer calculations of the time development of the droplet size distribution in fog;

FIG. 12 shows three examples of calculations of the time dependence of visibility in fog in which various fractions of droplets were positively charged;

FIG. 13 shows an example of the calculations of the time dependence of the visibility (at the time moment of 1800 sec) as a function of the fraction of positively charged droplets;

FIG. 14 shows an example of calculations of the time dependence of visibility in a dense fog in which the droplets were charged with bipolar charges; and

FIGS. 15A-15D are schematic views of exemplary configurations of electrodes that can be used with the charger of the apparatus of the present invention.

### DETAILED DESCRIPTION OF SPECIFIC EMBODIMENTS

The principles and operation of a method and an apparatus according to the present invention may be better understood with reference to the drawings and the accompanying description, it being understood that these drawings are given for illustrative purposes only and are not meant to be limiting.

The present invention provides a novel method and apparatus for controlling atmospheric conditions in a portion of the atmosphere for weather modification. The portion of the atmosphere may, for example, be a portion of a cloud or fog containing water droplets having different sizes dispersed therein.

The control of atmospheric conditions is carried out by controllably urging the collisions between the water droplets in the atmosphere so as to cause their controllable coalescence and precipitation. The urging is characterized by adjusting non-gravitational attraction forces between the droplets to a predetermined value so as to alter a collision rate between the water droplets to a desired value.

The collision rate is proportional to the collision efficiency and to the droplet concentration according to Eq. (4). Therefore, altering the non-gravitational attraction forces between the droplets can result in altering the effective collision rate, thereby causing the enhancement or reduction of coalescence and precipitation of the droplets in their motion under the force of gravity.

The changes of the non-gravitational attraction forces between the droplets are achieved by dosed seeding in a portion of a cloud or fog a seeding material that is electrically charged to a required magnitude and polarity. The required magnitude and polarity depend on (i) the size distribution of the droplets in the portion of the atmosphere, and on (ii) the size distribution of the elements of the seeding material.

According to the present invention, the required magnitude and polarity of the electrically charged seeding elements (particulate material and/or water droplets) are determined by utilizing an appropriate droplet collision model. The droplet collision model utilized for the purpose of the present invention will be described herein below. This model takes, inter alia, into account the size distribution of the droplets in the portion of the atmosphere, and the size distribution of the seeding elements. Accordingly, the size distribution of the droplets in the portion of the atmosphere should be determined advance.

According to one embodiment of the invention, the seeding material contains such seeding elements as fine particles of a particulate material having a predetermined particle size distribution.

According to another embodiment of the invention, the seeding material contains such seeding elements as water droplets. According to one example, the seeding water droplets are collected from the cloud or fog, and then electrically charged to a predetermined magnitude and polarity. According to another example, the seeding water droplets having a predetermined droplet size distribution are generated by a droplet generating device, e.g., an ultrasonic fog generator.

According to yet embodiment of the invention, the seeding material contains particles of a particulate material together with seeding water droplets. The size distributions of the seeding particles and droplets have predetermined values. The ratio between the concentrations of the particles and the water droplets has a required predetermined value.

The dosed seeding of the charged seeding materials (charged particles and/or water droplets) can control the concentration of the charged droplets in the cloud or fog as well as the charge magnitudes, and thereby can tune the non-gravitational (i.e., electric) interaction between the droplets. It should be noted that the electric interaction can take place both between the charged droplets themselves as well as between the charged droplets and the neutral droplets.

The charging of the elements of the seeding material (fine particles and/or water droplets) can be obtained, for example, by passing a particulate material and/or water droplets through an electric discharge, and/or by bringing the seeding material into contact with charged electrodes.

The droplets in natural clouds and fogs are usually electrically neutral and represent weak salt solutions. It means that the droplets contain a sufficient number of ions to be regarded as conductive particles. Upon the approach of a charged element (particle and/or water droplet) of the charged seeding material to an electrically neutral droplet at a distance sufficient for electrical interaction, a charge with a polarity opposite to the charge of the element is induced on the side of the droplet that is facing the particle. This induced charge causes a non-gravitational attraction, such as an electrical attraction between the element and droplet.

According to one example, the magnitude of the attraction force in air can, for example, be derived from the following equation (see, for example, B. I. Bleaney and B. Bleaney, Electricity and Magnetism, Oxford University Press, Third Edition, 1976, v. 1, p. 58):

$$F = \frac{{q}^{2}}{4 {πϵ}_{0}} [ \frac{R a}{{( {R}^{2} - {a}^{2} )}^{2}} - \frac{a}{{R}^{3}} ] ( R > a ) , \qquad ( 5 a )$$

where a is the radius of the neutral droplet, R is the distance between the centers of the charged element and the droplet, q is the element charge and ε₀=8.854·10⁻¹² F/m is the universal dielectric constant.

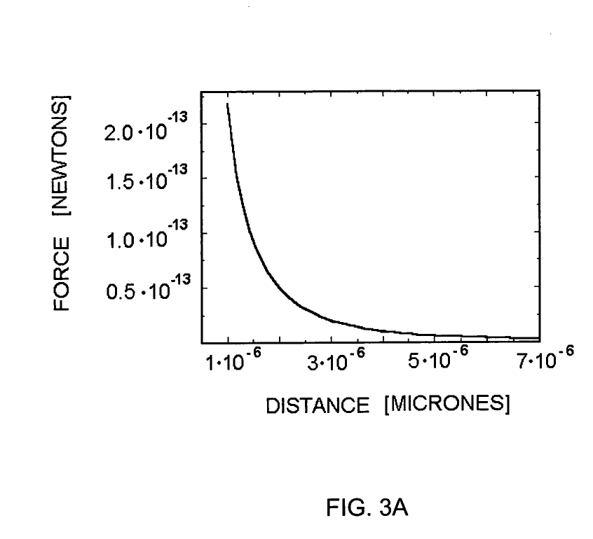

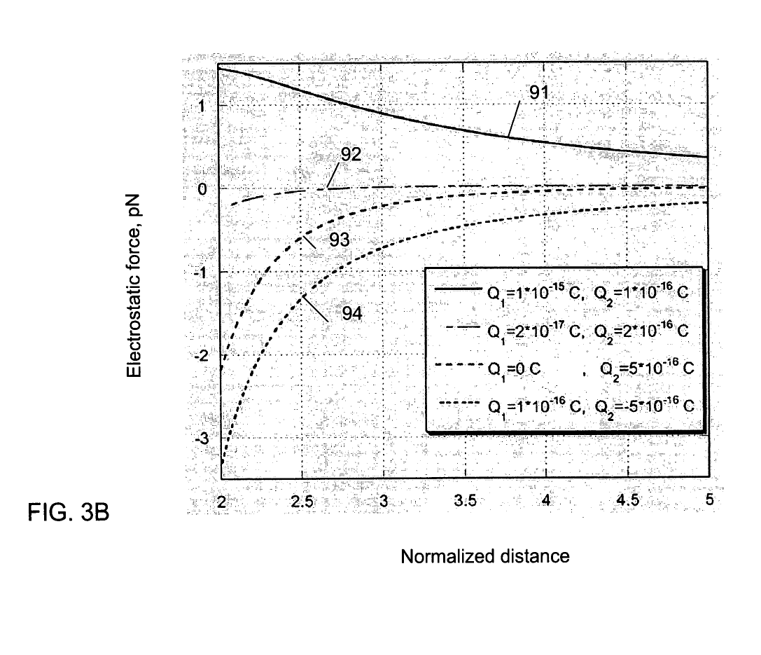

FIG. 3A illustrates the dependence of the electric attraction force between a droplet and a charged element (calculated by using Eq. (5a)) on the distance between the droplet and element. For this example, magnitudes of the element charge and the droplet radius were set to q=10⁻⁷ Coulomb and R=10 microns, respectively.

According to another example, the magnitude of the attraction force in air can be derived from the general approach of interaction of two conductive insulated spheres, which uses the method of electrical images and the potential and the capacitance coefficients corresponding to these spheres (see, for example, Batygin V. V., Toptygin I. N., Problems in Electrodynamics. London, Academic Press, 1978, 574 pp.). According to this approach, the magnitude of the attraction force in air between two conductive insulated spheres can be obtained by

$$\begin{matrix}{F}_{el} \approx \frac{{q}_{1} {q}_{2}}{4 {πϵ}_{0} {R}^{2}} + \\ \frac{1}{4 {πϵ}_{0}} ( {q}_{1}^{2} {r}_{2} ( \frac{1}{{R}^{3}} - \frac{R}{{( {R}^{2} - {r}_{2}^{2} )}^{2}} ) + \\ {q}_{2}^{2} {r}_{1} ( \frac{1}{{R}^{3}} - \frac{R}{{( {R}^{2} - {r}_{1}^{2} )}^{2}} ) + \\ {q}_{1} {q}_{2} {r}_{1} {r}_{2} ( \frac{1}{{R}^{4}} + \frac{1}{{( {R}^{2} - {r}_{1}^{2} - {r}_{2}^{2} )}^{2}} - \\ \frac{1}{{( {R}^{2} - {r}_{1}^{2} )}^{2}} - \frac{1}{{( {R}^{2} - {r}_{2}^{2} )}^{2}} ) )\end{matrix} \qquad ( 5 b )$$

where q₁ and q₂ are the charges of the conductive insulated spheres, r₁ and r₂ are the radii of the spheres correspondingly; R is the distance between the spheres' centers; and _{ε0}=8.854·10⁻¹² F/m is the universal dielectric constant.

It should be noted that the first term in Eq. (5b) represents the Coulomb forces that decaying with the distance R between the spheres as a function of R⁻². The second and third terms in Eq. (5b) represent the interaction forces between the point charges and the dipole. These forces decay with the distance between the spheres as a function of R⁻³. The three remaining terms describe the interaction forces between the induced charges, and these terms decay with the distance between the spheres as a function of R⁻⁴.

FIG. 3B illustrates examples of the dependency of the charged-induced force (calculated by using Eq. (5b)) between the differently charged conductive spheres on the distance R there between. For this example, magnitudes of the spheres' radii were set to r₁=10 micrometers and r₂=5 micrometers, correspondingly. The magnitudes of the charges of the spheres are shown in the inset in FIG. 3B.

It can be seen that when the both spheres are charged with the charge of the same sign, not only a repulsion (curve 91), but also attraction (curve 92) of the spheres can be observed, depending on the absolute values of the charges. It is important to mention here that these observations are different from the prior art assumptions. For example, U.S. Pat. No. 1,928,963 states that when the particles are all of the same sign, whether positive or negative, the particles are always kept apart by repulsion. The present invention utilizes the fact that the attraction between the charged spheres can take place not only for the case when the elements are charged with the charges having the opposite polarity (curve 94), but also for the cases when one of the droplets is neutral (curve 93), or when the both droplets are charged with the charge of the same sign (curve 92).

Since the water droplets in natural clouds and fog are usually neutral, the attraction force between neutral and charged droplets turns out to be very significant. The attraction between neutral and charged droplets is attributed to the fact that one of the droplets, within an electrical field induced by its counterpart droplet, becomes a dipole.

It should be noted that for the sizes of the spheres different from those shown in this example, the magnitudes of the charges, for which the attraction of the spheres is observed, can be also different. Therefore, in practice, the droplet size distribution of clouds or fog must be determined and taken into account when the charge magnitudes of the seeding elements are selected.

This attraction between the charged element and the droplet results in a close approach and capture of the charged element by the droplet. The droplet that received the charge from the charged element can, in its turn, attract another electrically neutral droplet with consequent approach and coalescence that would not be possible in the case of pure gravity-induced attraction. These attractions increase the collision efficiency between the droplets and the rate of their collisions, which in turn foster the formation of large droplets leading to raindrops in clouds. In case of fog, it leads to the elimination of small droplets, due to their collisions and coalescence, which results in fog dissipation.

The maximal value to which a seeding element should be electrically charged must also be taken into account in calculating collision efficiency and collision rate. In particular, a cloud droplet located in the air cannot be charged more than with a certain maximum value qₘₐₓ that is determined by the air breakdown electrostatic intensity E_{b}. It is known for corona discharge that the air breakdown electrostatic intensity E_{b} is about 3·10⁶ V/m (see, for example Meek and Craggs, 1953 Electrical Breakdown of Gases. Clarendon Press, Oxford, 507 p.).

The electrostatic intensity in the vicinity of a charged spherical particle can, for example, be calculated by using the well-known relationship E=q/4πε₀r². The magnitude of the maximal possible charge of a cloud droplet can be evaluated from the condition E=E_{b}, which gives

qₘₐₓ=4πE_{b}ε₀r² (6)

wherein r is the droplet's radius.

For example, for a droplet having the radius of 1 micrometer the maximal possible charge has the magnitude of qₘₐₓ=3·10⁻¹⁴ Coulomb, while a droplet with the radius of 10 micrometers has qₘₐₓ=3·10⁻¹⁶ Coulomb.

It should be appreciated that when the charge of a cloud droplet is higher than qₘₐₓ, the electrostatic intensity in the vicinity of the surface of this charged droplet exceeds E_{b} value, thus a corona discharge immediately appears. This corona discharge process reduces the charge of the droplet to the value qₘₐₓ, at which the corona discharge stops.

Likewise, it should be taken into account that even in case when the droplet's charge Q is less than qₘₐₓ the charge may sink owing to the conductivity of air, provided by the mobility of free ions in the air. In this case, a charged droplet slowly loses its charge according to the exponential law Q=Q₀ exp (−t/τ), where r=ε₀/σ is the relaxation time, σ is the conductivity of air and Q₀ is the initial charge of the droplet (see, for example, Pruppacher and Klett, 1997 “Microphysics of Clouds and Precipitation. Kluwer Academic Publishers,” Dordrecht/Boston/London, chapter 18, p. 794).

For example, for the fair weather conductivity at the sea level was estimated to be about 10⁻¹⁴ Sm/m that for the relaxation time gives the value of about 6.5 min. However, the conductivity inside a cloud can be significantly lower than the fair weather sea level conductivity, because the concentration of free ions inside a cloud can be significantly lower than that of ions in the air. Thus, Pruppacher and Klett (1997 Chapter 18, p. 802) estimated that the conductivity inside a cloud is in the range of 1/40 up to ⅓ of the fair weather sea level conductivity, which leads to the values of the relaxation time between 20 min and 4 hours. In other words, the time period of droplet discharge can be much longer than the time scale of the coagulation processes leading to the raindrop formation, which are typically about 10 min for cumulus clouds.

In order to understand the manner in which the collision efficiency between the droplets depends on the sizes and electrical charges of the element (or droplets), and to see how the collision efficiency can be altered to a desired value in practice by varying these parameters, several non-limiting examples of computer simulations are described hereinafter in details.

In general, for the purpose of the invention, the elements utilized for seeding may have a spread of sizes ranging from sub-micron to several microns size, e.g., between 0.1 and 20 microns. The charge may have negative or positive polarity, and maximum magnitude of such charged elements may, e.g., range from about ±10⁻¹⁶ Coulomb to about ±10⁻¹² Coulomb.

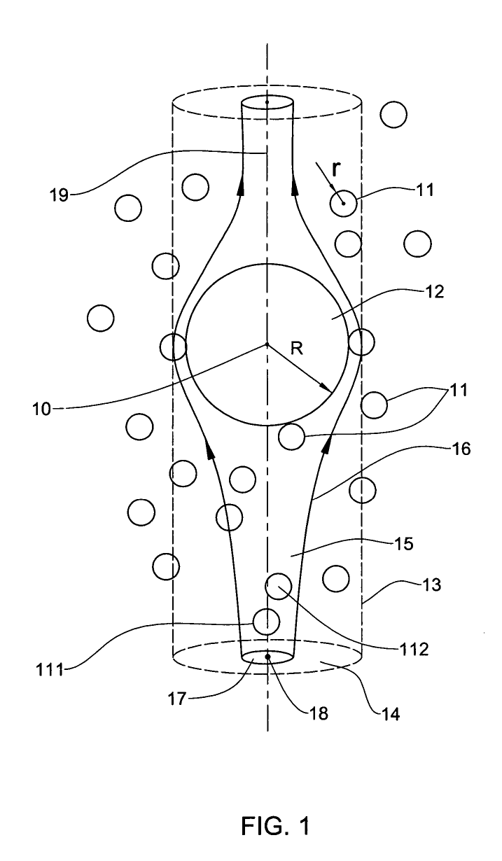

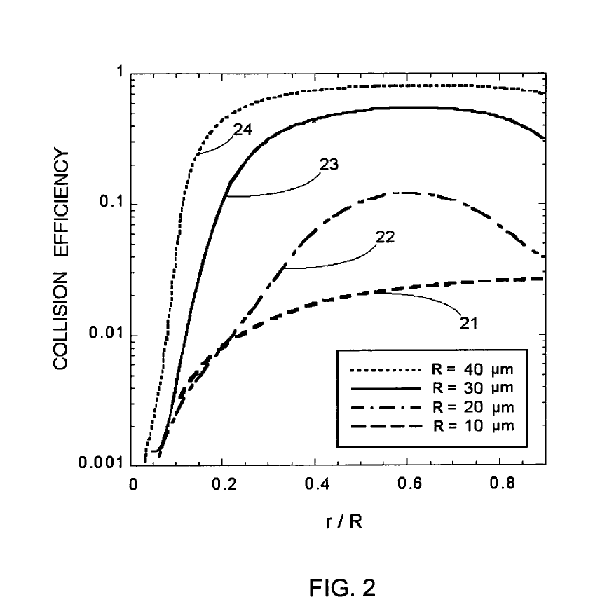

The collision efficiency can be calculated by utilizing Eq. (3). Turning back to FIG. 1, an example of the case of axisymmetric geometry of the collisions is illustrated. In this example, the collision cross section 17 is a circle having a center 18 located on a vertical axis 19 passing through a center 10 of the large drop 12.

A calculation of a radius of the collision cross section 17 can be carried out by numerical simulation experiments of the approach of the small droplets 11 to the large drop 12. For the purpose of the numerical experiments, various state-of the-art mathematical models can be used for a hydrodynamic description of the droplet motions. For example, a known per se superposition method can be considered, according to which each droplet is assumed to move under the gravitational, electric, buoyancy and drag forces in the flow induced by its counterpart moving alone.

According to the superposition method, the equation of motion of elements 1 and 2 during their hydrodynamic interaction can, for example, be represented by

$$\frac{ⅆ {\vec{V}}_{1}}{ⅆ t} = - \frac{1}{{τ}_{1}} ( {\vec{V}}_{1} - {V}_{1 t} {\vec{e}}_{z} - {\vec{u}}_{2} ) + \frac{{\vec{F}}_{el}}{{m}_{1}} , \\ \frac{ⅆ {\vec{x}}_{1}}{ⅆ t} = {\vec{V}}_{1} , \\ \frac{ⅆ {\vec{V}}_{2}}{ⅆ t} = - \frac{1}{{τ}_{2}} ( {\vec{V}}_{2} - {V}_{2 t} {\vec{e}}_{z} - {\vec{u}}_{1} ) - \frac{{\vec{F}}_{el}}{{m}_{2}} , \\ \frac{ⅆ {\vec{x}}_{2}}{ⅆ t} = {\vec{V}}_{2} , \qquad ( 7 )$$

where \overline{x}₁ and \overline{x}₂ are the radius-vectors of the elements 1 and 2, \vec{V}₁ and \vec{V}₂ are the velocity of the elements 1 and 2, \vec{V}₁, \vec{V}₂, are the terminal velocity of the elements 1 and 2 in calm atmosphere, \vec{u}₁ is the perturbed velocities induced by the element 1 at the location of the element 2, \vec{u}₂ is the perturbed velocities induced by the element 2 at the location of the element 1, \vec{e}_{z} is the unit vector directed downward, τ₁=\vec{V}₁ₜ/g and τ₂=\vec{V}₂ₜ/g are the characteristic relaxation time of the elements 1 and 2, which are the measure of the inertia of the elements 1 and 2, m₁ and m₂ are the masses of the elements 1 and 2, \vec{F}ₑ₁ is the electrostatic force that can be derived by using Eq. (5), and g=9.8 m/s² is the free fall acceleration.

The system of equations (7) can, for example be used for the calculations of the collision efficiency between the drop 12 and the small droplet 111. For this purpose, a procedure can be used described in the following publications:

M. Pinsky, A. Khain, and M. Shapiro, “Collisions of small drops in a turbulent flow. Pt.1: Collision efficiency: problem formulation and preliminary results,” J. Atmos. Sci., 1999, v. 56, p. 2585-2600; and

M. Pinsky, A. Khain, and M. Shapiro, “Collision efficiencies of drops in a wide range of Reynolds numbers: Effects of pressure,” J. Atmos. Sci., 2001, v. 58, p. 742-764.

According to this procedure, at the beginning of the simulation, a mutual motion of the large drop 12 relative to one small droplet (111 in FIG. 1), that is selected from the droplets 11, can be carried out. The selection of the small droplet 111 is subject to the condition that it is located on the axis 19 below the large drop 12 at a distance of larger than 30 R (i.e., 30 radii of the large drop) from the large drop 12. The distance is selected subject to the condition that at the start of the simulation, the electric and hydrodynamic interactions between the drop 12 and the droplet 111 should be insignificant. During motion under gravity, the large droplet moves faster than the small droplet owing to the counteracting electrical, buoyancy and drag forces and attains the distance at which the interactions start to affect the droplet relative motion that results in their collision.

In the next step of the simulation experiment, a hydrodynamic motion of another selected small droplet (for example a droplet 112) relative to the large drop 12 can be considered. The droplet 112 can also be placed at the distance of 30 R from the large drop 12. However, the initial distance of small droplet 112 from the vertical axis 19 should be successively increased.

Thereafter, the simulation experiment can be continued with a consequent increase of the initial distance of the small droplet from the vertical axis 19. In each of these simulations, the grazing trajectories of the approach of the small droplets to the drop collector and variations in time of the distances between the small droplets and the large drop can be calculated. The system of equations (7) can, for example, be solved by using the fifth order Runge-Kutta method with automatic precision control and automatic choice of the integration time step (see, for example, W. H. Press, et al., Numerical Receipts in FORTRAN, 1992, Cambridge Press, 963 p).

It should be appreciated that the collisions between the small droplets and the large drop may take place only when the initial deviations of the small droplets from the vertical axis are relatively small. On the other hand, when the initial deviations start to exceed a certain value, the small droplets will move around the large droplet together with the airflow without collisions. This distance (deviation) separating a zone of collisions from the non-collision zone can be defined as a radius R_{col} of the collision cross-section 17. Accordingly, the area S of the cross can be obtained by S=πR_{col}², and the collision efficiency E can be derived from Eq. (3).

According to one embodiment of the invention, the large drop 12 can be considered to be electrically neutral and the small droplets 11 to be electrically charged. In this case, in order to adjust the collision efficiency to a desired value the simulations can be run for various sizes and charges of the large drop as well as various sizes and charges of the small droplets.

It should be understood that a collision efficiency between the droplets and particles, when necessary, can be calculated in the same manner as the collision efficiency between the drops and droplets.

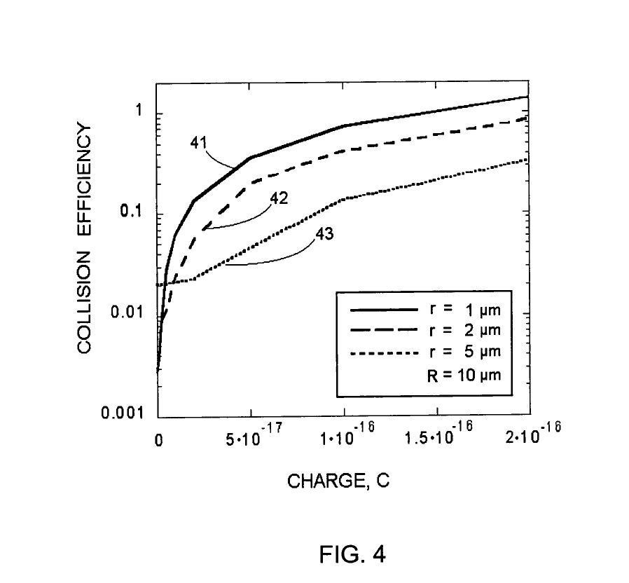

Referring now to FIG. 4, three examples of calculations of the collision efficiency between the drop-collector and droplets (particles) as a function of the droplet (particle) charge are illustrated. In these examples, the size of the drop-collector is 10 microns in radius and the sizes of the small droplets (particles) are 1 micron (curve 41), 2 microns (curve 42) and 5 microns (curve 43), respectively. This situation of the droplet sizes is typical for cumulus clouds. However, it should be noted that if a droplet radius in fog have a magnitude of up to 10 microns, then FIG. 4 serves also as illustration for the fog conditions.

It can be seen that in the absence of electrical attraction between the droplets (i.e., when the drop and droplets are not charged), the collision efficiency has a magnitude of about 0.003, 0.01 and 0.02 for the droplets having the size of 1 micron, 2 microns and 5 microns, respectively. This means that the drop and droplets, in fact, do not collide over a reasonable period of time.

However, the situation changes when the droplets are charged. In this case, the collision efficiency between the drop-collector and the 5 micron droplet increases by about 10 times, when the droplet receives a charge having a value of about 2·10⁻¹⁶ Coulomb (see curve 43).

The collision efficiency increases even more drastically for the droplets having radii of 1 micron and 2 microns. Thus, the collision efficiency increases by about two orders of magnitude for the droplets having a radius of 2 microns (see curve 43) and by about three orders of magnitude for the droplets having a radius of 1 micron (see curve 43).

It can be noted that the magnitude of the collision efficiency for certain situations can exceed 1 (see curve 41). In other words, the collision cross section (17 in FIG. 1) is larger than the geometrical cross-section (14 in FIG. 1), meaning that even the droplets located outside the volume of the cylinder (13 in FIG. 1) participate in the collisions. In general, by utilizing the technique of the invention, the collision efficiency may be varied in a rather broad range, for example, from 0.001 to 1000.

It should be appreciated that in contrast to the teaching of the prior art, the computer experiment shows that collision efficiency for the smaller droplets (particles) for certain charge values can be higher than the collision efficiency for the larger droplets (particles). This unexpected result provides an advantage of the method of the present invention that was unappreciated hitherto. As was mentioned above, one of the major requirements of the prior art techniques was producing large seed particles, since the small particles are not effective for creating large drop-collectors. In particular, the techniques based on seeding combustion products obtained by burning are not sufficiently effective since the combustion product contain mainly small particles. Thus, the main drawback of the prior art technique that militates against the use of small seed particles is overcome by the invention and actually used to advantage.

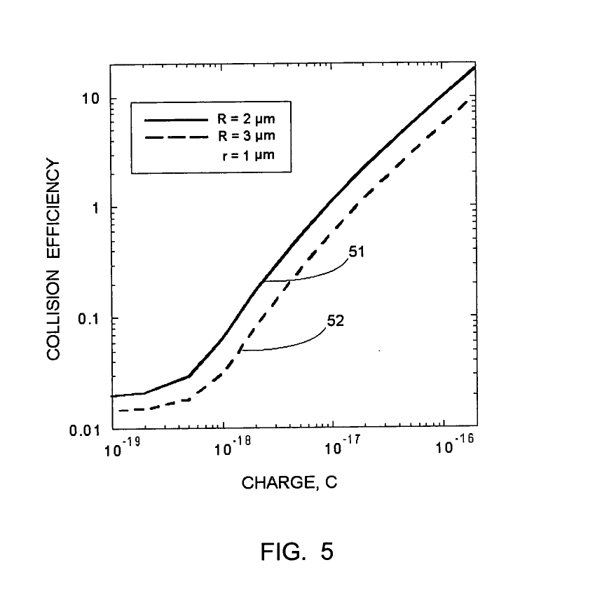

FIG. 5 illustrates examples of calculations of the collision efficiency for a situation relevant to fogs containing relatively small droplet (1-3 microns). The collision efficiency is calculated as a function of the droplet (particle) charge for the drop-collectors having radius of 2 microns (see curve 51) and 3 microns (see curve 52) interacting with the small droplets (particles) having the radius of 1 micron. In the case when the droplets are uncharged the collision efficiency is about 10⁻². However, the collision efficiency between the neutral and charged droplets increases by 2 to 3 orders of magnitude, depending on the charge value.

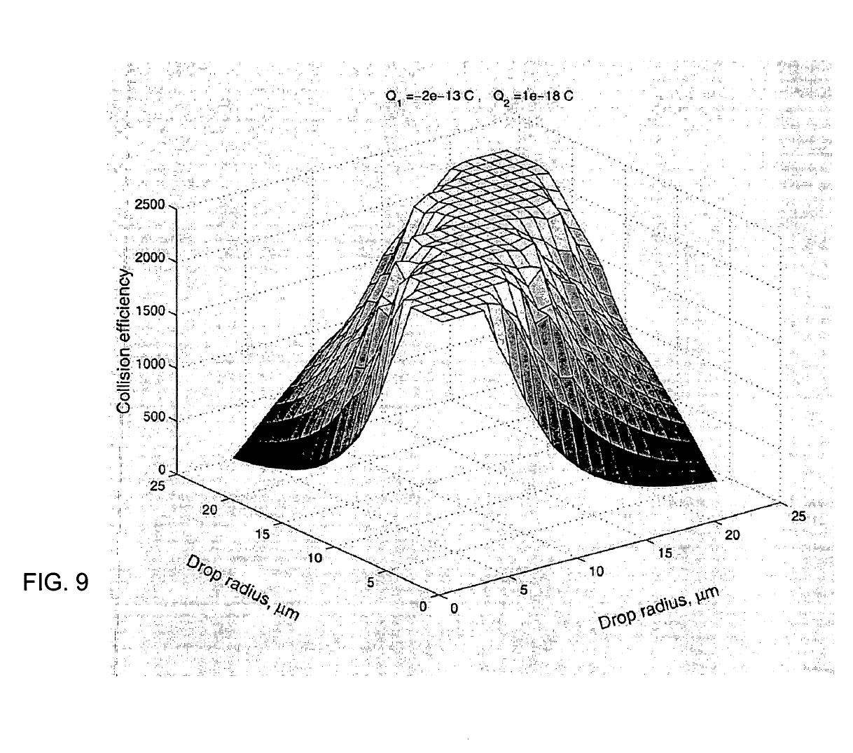

FIG. 9 is a three-dimensional plot showing a general example of the collision efficiency as the function of radii for two elements having the charges of Q₁=−2·10⁻¹³ Coulomb and Q₂₌1·10⁻¹⁸ Coulomb. As can be seen, the collision efficiencies may reach rather high values exceeding 1000, i.e., several thousand times higher than the collision efficiencies associated with the pure gravitational interaction between the elements.

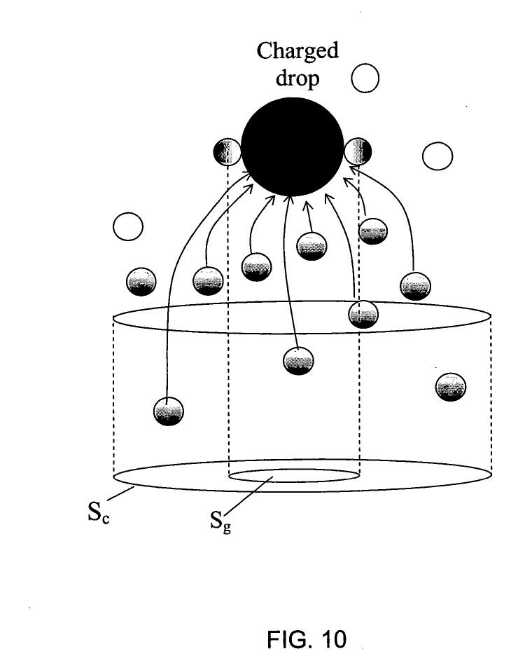

FIG. 10 shows a scheme of collisions of small droplets with an electrically charged drop-collector. This scheme summarizes the results of the examples shown in FIGS. 4, 5 and 9, and illustrates that an electrically charged drop collector can collect droplets within the region having the collision cross-section S_{c} significantly exceeding the geometrical cross section S_{g}.

As can be appreciated from the description above, the controllable variation of the size and electrical charge of the seeding elements enables to alter the collision efficiency in a broad range to a desired value, and thereby to control the atmospheric conditions. Hereinbelow, several examples of the controlling of atmospheric conditions are illustrated.

First, the examples that follow below illustrate how the controllable variation of size and electrical charge of the seeding elements enables to control the visibility in fog. The efficiency of the fog abatement techniques can be characterized by improvement of visibility in fog after the injection of seeding elements. The visibility (VIS) is related to the extinction coefficient β by the known equation:

$$VIS = \frac{ln ϵ}{β} \qquad ( 8 )$$

where ε is the contrast threshold, usually equal to 0.02 (see, for example, B. A. Kunkel, “Parameterization of droplet terminal velocity and extinction coefficient in fog models”, Journal of Climate and Applied Meteorology, 1984, v. 23, p. 34-41). The extinction coefficient β characterizes the rate of the weakening of light beam energy in fog. It is known (see, for example, Zuev V. E. “Propagation of visible and infrared radiation in the atmosphere”, Israel Program for Scientific Translations Ltd, Halsted Press, New York-Toronto-Jerusalem-London, 1974, p. 230), that the extinction coefficient β depends on the droplet size distribution in fog, and can be calculated by using the following equations:

$$\begin{matrix}β = N {\int }_{0}^{∞} π {a}^{2} K ( ρ ) f ( a ) ⅆ a , \\ where & ( 9 ) \\ K ( ρ ) = 2 - \frac{8 {n}^{2} sin [ 2 ρ ( n - 1 ) ]}{{ρ ( n + 1 )}^{2} ( n - 1 )} , and ρ = \frac{2 π a}{λ} , & ( 10 )\end{matrix}$$

where N is the droplet concentration, a is the droplet radius, f(a) is the droplet size distribution function in fog (or in a cloud), n=1.33 is the refractive index of water and λ is the wavelength of the scattered radiation. In the present example, the wavelength λ=500 nanometers (green light) have been selected, that corresponds to the center of the visible range of the light spectrum.

For deriving the time dependence of visibility in fog, the time evolution of the droplet size distribution caused by the droplet collisions must be determined. It is known in the art that the evolution of the droplet spectrum with time can be obtained by solving the stochastic collision (collection) equation (SCE) (see, for example, Pruppacher and Klett, Microphysics of Clouds and Precipitation. Kluwer Academic Publishers, Dordrecht/Boston/London, 1997, 954 p.):

$$\begin{matrix}\frac{\partial f ( m , t )}{\partial t} = {\int }_{0}^{m / 2} f ( {m}_{c} , t ) K ( {m}_{c} , {m}^{′} ) f ( {m}^{′} , t ) ⅆ {m}^{′} - \\ {\int }_{0}^{∞} f ( m , t ) K ( m , {m}^{′} ) f ( {m}^{′} , t ) ⅆ {m}^{′} ,\end{matrix} \qquad ( 11 )$$

where f(m,t) is the drop mass (or number) distribution function at the time t and K(m_{c},m′) is the collection kernel describing the rate, at which the drop of the mass of m_{c}=m−m′ is collected by the drop of the mass m′, forming further the drop of the mass m. The first integral on the right hand side of Eq. (11) (the so-called “gain”) describes the gain of the drops of mass m, owing to the collision and coalescence of two smaller drops, while the second integral (the so-called “loss integral”) denotes the loss of the drops of mass m, owing to the collisions with other drops of any mass (size).

Thus, by solving the stochastic collision equation (11), the time evolution of the initial droplet spectrum can be obtained. For the numerical solution of the SCE, for example a numerical approach described in the article of A. Khain, et al., titled “Notes on the state-of-the-art numerical modeling of cloud microphysics” and published in Atmos. Res. 2000, v.55, p.159-224 can be utilized.

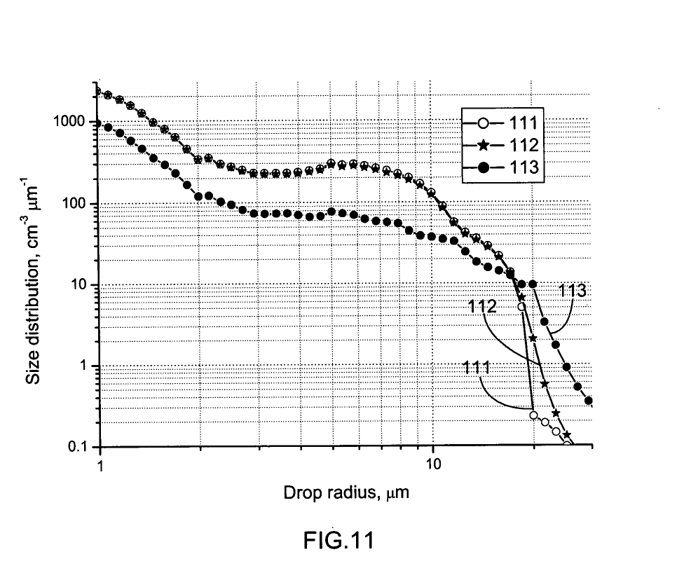

Referring to FIG. 11, the results of the computer calculations of the development of the droplet size distribution (DSD) are illustrated for the natural fog described in the article titled “The physics of radiation fog: I—a field study”, by W. T. Roach, R. Brown, S. J. Caughey, J. A. Garland and C. J. Readings, published in Ouart. J Roy. Met. Soc., 1976, v. 102, p. 313-333. Such a DSD is typical for a fog with the total liquid water content of 0.2 g·m⁻³ and the droplet concentration of 1400 cm⁻³. The curve 111 (marked by the open circles) corresponds to the fog's DSD at the initial time moment. The curve 112 (marked by the open stars) corresponds to the DSD of the fog with neutral droplets after the fog development over 1800 seconds. Accordingly, the curve 113 (marked by filled circles) corresponds to the DSD of the fog in which 30% of the droplets are charged positively and another 30% of the droplets are charged negatively. As can be seen, when the droplets remain electrically neutral (the curves 111 and 112), the DSP remains almost unchanged over the period of 1800 seconds. However, when the fog contains a fraction of electrically charged droplets, a significant decrease of the concentration of the droplets within the size range of 1 to 10 micrometers is observed after the fog development, that indicates a formation of large droplets.

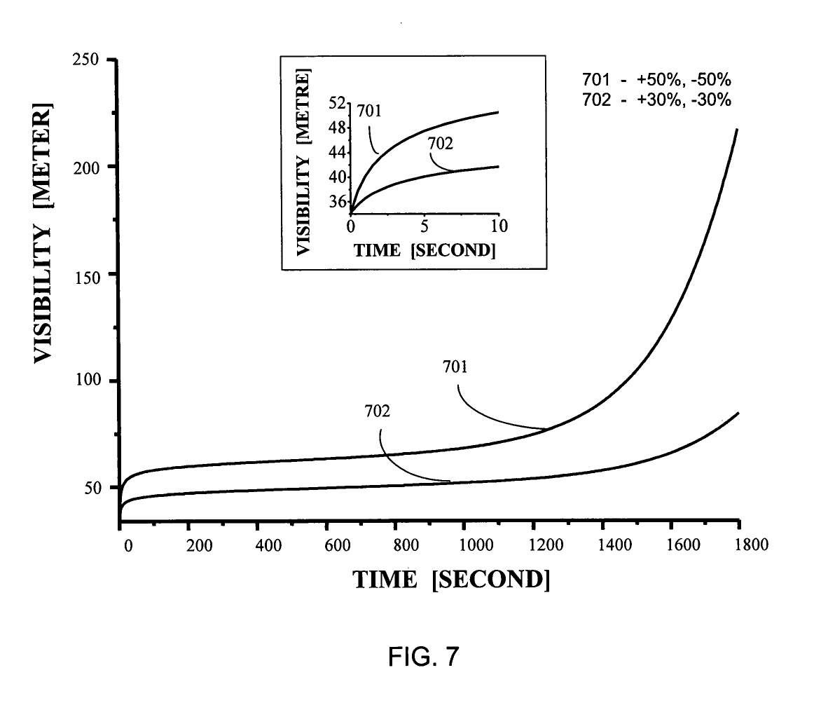

FIG. 7 illustrates two examples of calculations of the time dependence of visibility in fog having the droplet spectrum shown in FIG. 11. As can be seen, the initial visibility (before seeding) in the fog equals 34 m. In the present calculations, the fog droplets were assumed to be charged at time of 0 seconds (t=0s). The magnitude of the charge, selected for the calculations, depends on the droplet size, and varies in the range of about ±10¹⁴ Coulomb for the droplets having 1 micron radius to about ±10⁻¹² Coulomb for the droplets having 20 micron radius, respectively.

In the case when 50% of the droplets within a certain volume of the fog are initially charged by one polarity charges, and another 50% of the droplets within the same volume are charged by the opposite polarity charges, the visibility in the fog increases from 34 m at the time t=0 s to 240 m at the time t=1800 s (see FIG. 7, curve 701). As can be seen, a rather rapid increase in the fog visibility is observed during the first 5-10 seconds. For instance, the visibility increases from 34 m to 52 m over the first ten seconds (see curve 701 in the inset in FIG. 7).

In the case when 30% of the droplets are initially charged by one polarity charges and 30% of the droplets are charged by the opposite polarity charges, the visibility increases from 34 m to 43 m over the first 10 seconds, and then increases to 75 m by the time period of 1800 seconds (see FIG. 7, curves 702). The calculations show that the visibility continues to increase also after 1800 seconds. That indicates that the collision processes in the selected fog volume, triggered by the seeding, still continue with the further decreasing of the droplet concentration.

Thus, in the case of the bipolar fog charging, there are three main stages of the fog development. At the first stage (over about the first 10 s of the fog evolution) the collisions of oppositely charged droplets lead to a rather fast enhancement of visibility from 35 m up to 40 m. These collisions shift the fog DSD towards the region of larger droplets. Then, at the second stage (over about 20 min), the fog evolution is mainly governed by the gravity-induced collisions, and the visibility improves slowly. However, these gravity collisions lead to the creation of some amount of large droplets, which later trigger the fast collision process observed at the further third stage.

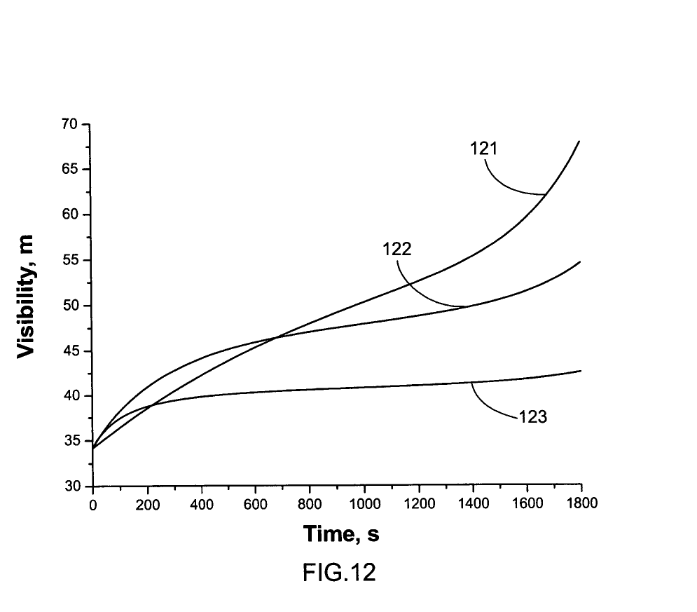

FIG. 12 shows three examples of calculations of the time dependence of visibility in fog in which various fractions of droplets are positively charged. The numerical simulations were carried out for the cases when 10%, 30% and 60% of the droplets are positively charged (see curves 121, 122 and 123, respectively). As can be appreciated, these examples are different from the above examples shown in FIG. 7 in the fact that the droplets were charged with only one-polarity charges.

As can be seen, the unipolar charged fog does not reveal the three stages of development, found in case of the bipolar charged fog. Contrary to the bipolar charged fog, the electrostatic effects in the fog charged with unipolar charges are significant over the whole period of the fog evolution, but not just over the fist 10 seconds.

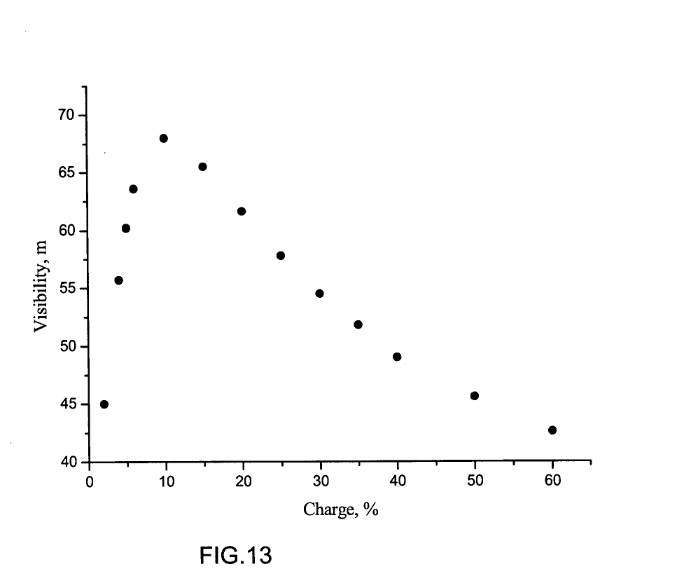

Referring to FIG. 13, an example of the calculations of the time dependence of visibility (at the time moment of 1800 s) as a function of the fraction of the positively charged droplets is illustrated. As can be appreciated, there is an optimal concentration of the droplets charged with unipolar charge, at which the enhancement of the visibility has a maximum. One of the possible explanations of this phenomenon is the following. In the natural fog, in which all the droplets are neutral, the gravity-induced collisions are inefficient, and therefore do not lead to the DSD development and fog elimination. Likewise, in the completely charged fog (i.e., where 100% of the droplets are charged), the gravitational collisions are drastically suppressed by the Coulomb repulsion. Hence, there is an optimum between these two ineffective situations. For the example of the DSD used in these simulations, the optimum occurs at 10% of the unipolar charged droplets.

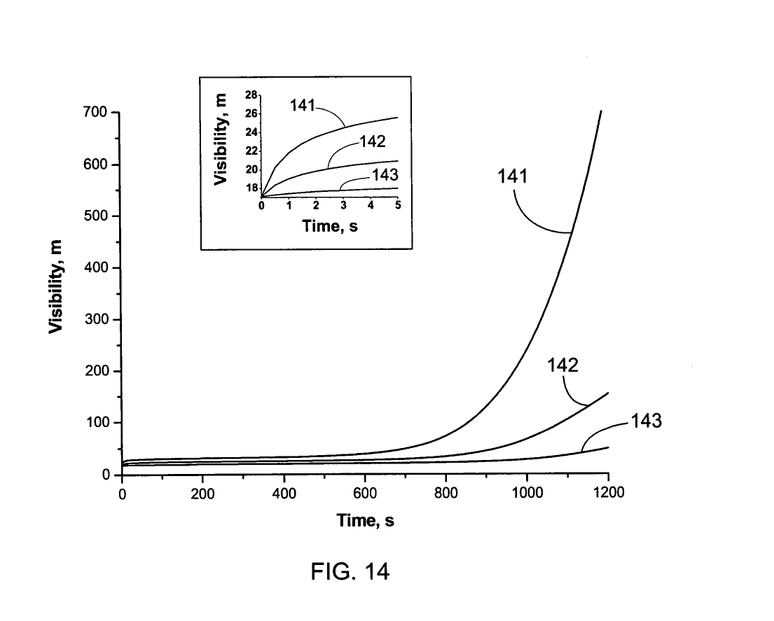

Referring to FIG. 14, an example of the calculations of the time dependence of visibility in a dense fog in which the droplets are charged with bipolar charges is illustrated. In this example, the DSD similar to that used in the previous examples have been used, while with the double droplet concentration. It should be noted that such a fog can be considered as a quite dense fog, which is of a special danger for aviation and vehicular traffic. A curve 141 corresponds to the case when 50% of the droplets were charged with a positive charge and another 50% with a negative charge. A curve 142 corresponds to the case when 30% of the droplets are positively charged, while 30% are negatively charged. Accordingly, a curve 143 corresponds to the case when 10% of the droplets are positively charged while 10% are negatively charged. The figure in the inset shows the beginning stage of the fog evolution.

The calculation shows an unexpected result, namely, the dense fog, having initially a smaller visibility than that in the less dense fog of the example shown in FIG. 12, is eliminated faster. In particular, the visibility of the fog over 15 min becomes larger than that in the case of the less dense fog. This result can, inter alia, be attributed to the fact that the active coagulation stage in the dense fog in the presence of charged droplets starts earlier and runs more efficiently than in the less-dense fog.

The efficiency of the cloud seeding technique can be measured by the mass of the precipitating raindrops produced by seeding the clouds, which initially contain only non-precipitating cloud droplets. Since different clouds contain different amount of liquid water, the seeding efficiency can be characterized by the ratio between the raindrop content (i.e., the mass of the raindrops per unit of volume) and the total cloud water content. This ratio hereinafter will be referred to as a “relative rainwater content”.

It should be appreciated by a person skilled in the art that in the case of a cloud that contains only non-precipitating cloud droplets, the relative rainwater content is equal to zero. On the other hand, when the cloud contains only precipitating raindrops, the relative rainwater content is equal to one.

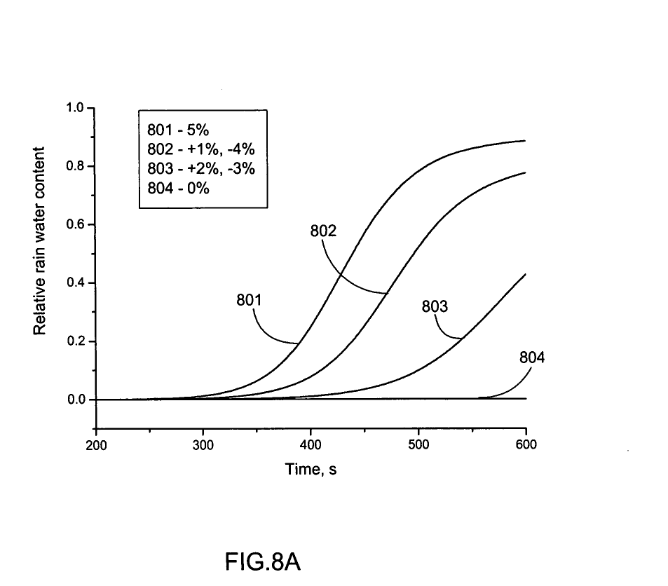

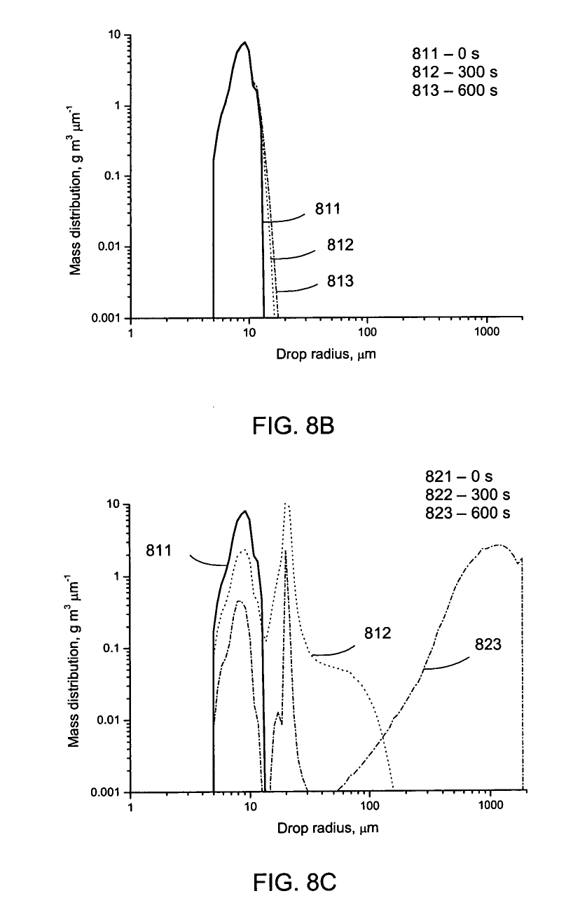

Referring to FIGS. 8A-8C, examples of the calculations of the time dependence of the relative rainwater content in a cloud and evolution of droplet mass distribution are illustrated for the cases of uncharged initial droplets and when a part of the initial droplets are electrically charged.

The results are obtained by solving the stochastic collection equation, similar to that used in the case of fog. A cloud droplet spectrum measured by Rosenfeld and Woodley in the summertime Texas clouds on 13 Aug. 1999 (see the paper titled “Deep convective clouds with sustained highly supercooled liquid water until −37.5° C.”, published in Nature, 2000 v. 405, p. 440-442) was selected as an example for the present calculations.

The clouds investigated by Rosenfeld et al. have a rather narrow droplet mass (size) distribution shown in FIG. 8B (curve 811). The size distribution is centered at about 9 micron in radius with the total cloud water content of 3 g m⁻³ and droplet concentration of 1100 cm⁻³. Such clouds do not produce rain (or produce negligible rain amount) under the natural conditions. FIG. 8B illustrates that in the case of initially uncharged droplets, the development of the droplet mass distribution is not significant (see curves 812 and 813 corresponding to t=300 sec and t=600 sec, respectively). A calculated curve 804 in FIG. 8A, corresponding to this case indicates that the rain water content (indicating the formation of raindrops) is constant always and equal to zero over the calculated period of time of 600 seconds. In other words, no rain drops are formed.

FIG. 8C illustrates droplet mass distributions at t=0 (curve 821), t=300 sec (curve 822) and t=600 sec (curve 823) in the case when 5% of the cloud droplets of the initial droplet size distribution within a certain cloud volume are charged with the same polarity charges. It was assumed in the calculations that all charged droplets are distributed homogeneously within a certain cloud volume, owing to the turbulent mixing. The results show a crucial influence of droplet charges on the coagulation process. As can be seen, after 5 min of evolution, the droplet mass distribution demonstrates a pronounced tail corresponding to small raindrops in the radius range of 50-100 micrometers (curve 822). In the further 5 minutes, the radius of drops increases up to 1 millimeter (curve 823).

Turning back to FIG. 8A, calculated curve 801 illustrates a development of the rain water content corresponding to this case. On the other hand, as was mentioned above, the droplet mass distribution, corresponding to the case of uncharged initial droplets (see FIG. 8B), practically does not develop over the same time period.

As was noted above, the maximum magnitude of the charge depends on the droplet size. For the purpose of the calculations, the magnitude of the charge, varies in the range of about ±10⁻¹⁴ Coulomb (for the droplets having 1 micron radius) to about ±10⁻¹² Coulomb (for the droplets having 20 micron radius), respectively.

One can see that the charging of the cloud droplets leads to a relatively rapid rain formation. Thus, after injecting charged seed elements, the relative rainwater content increases from zero (at time period of about t=300 s) to 0.85 (at t=540 s). These results show that 85% of the initial droplet mass transfers to the precipitating rain drops over a rather short period of time, e.g., about 250 seconds.

A calculated curve 802 in FIG. 8A shows the rain formation in the case when 1% of the droplets in the initial droplet size distribution are charged with one polarity charges, while 4% of the droplets are charged with the opposite polarity charges. In turn, a calculated curve 803 illustrates the rain formation in the case when 2% of the cloud droplets in the initial droplet size distribution are charged by one polarity charges, while 3% of the droplets are charged with the opposite polarity charges. One can see that the seeding of clouds with the charged elements leads to a rather rapid rain formation.

As can be appreciated from the illustrated calculations, the unipolar cloud seeding (curve 801) produces more rain over the same period of time, as compared to the bipolar cases, when the seeding of the cloud was carried out by the elements charged with the opposite polarity charges (curves 802, 803). It should be noted that this observation is drastically different from the situation considered in fog, where the bipolar seeding produced better fog elimination than the unipolar seeding.

Thus, in order to obtain fast increase of visibility in fog, the seeding elements are preferably charged with the opposite polarity charges. In turn, in order to obtain the maximum rain enhancement, the seeding elements are preferably charged with the same polarity charges. In all the cases, the charge magnitudes of the seeding elements should be calculated by using the collision model, as described above.

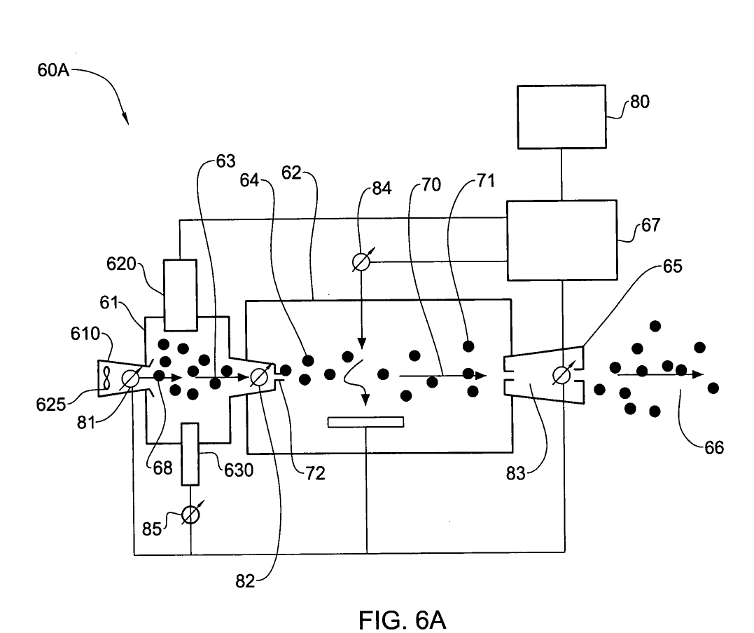

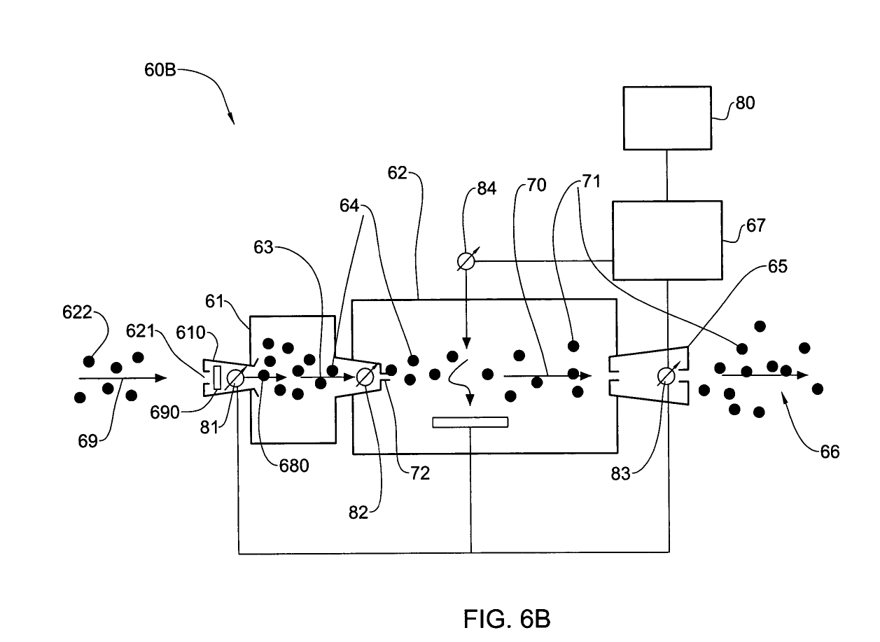

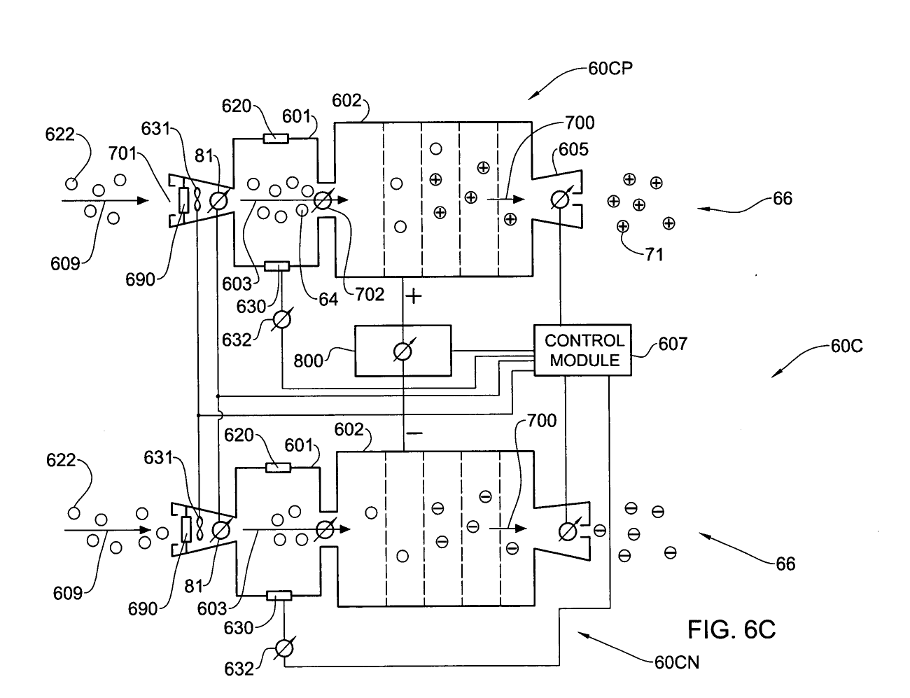

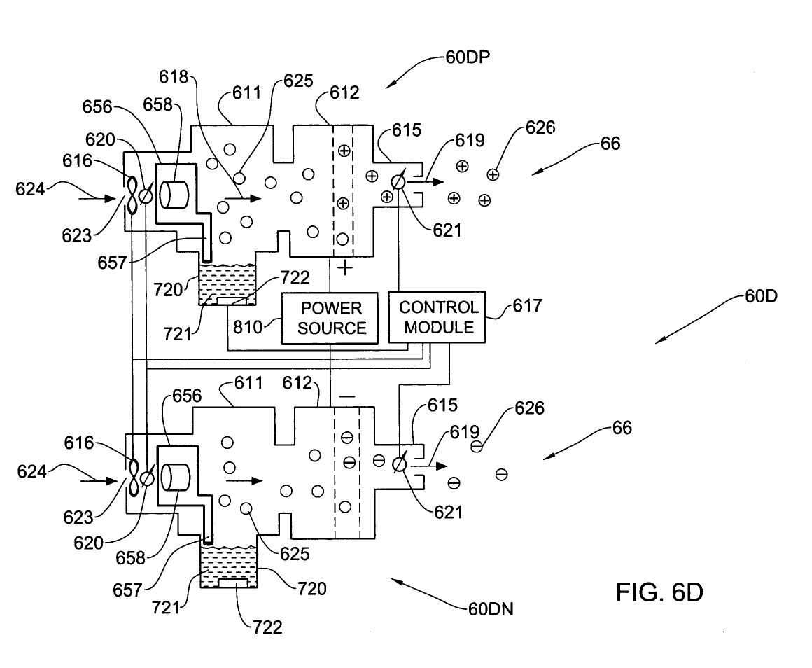

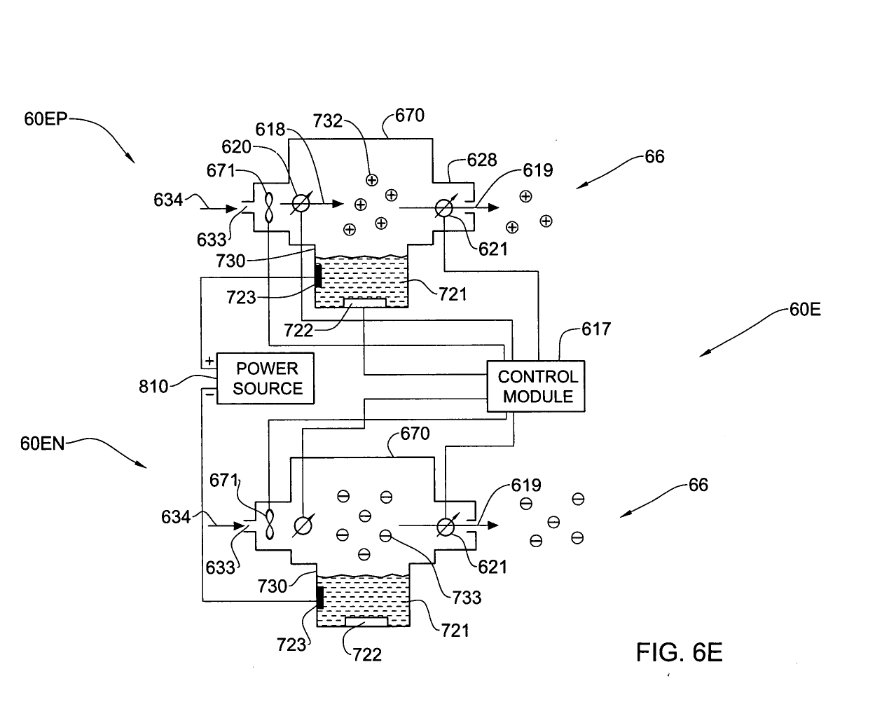

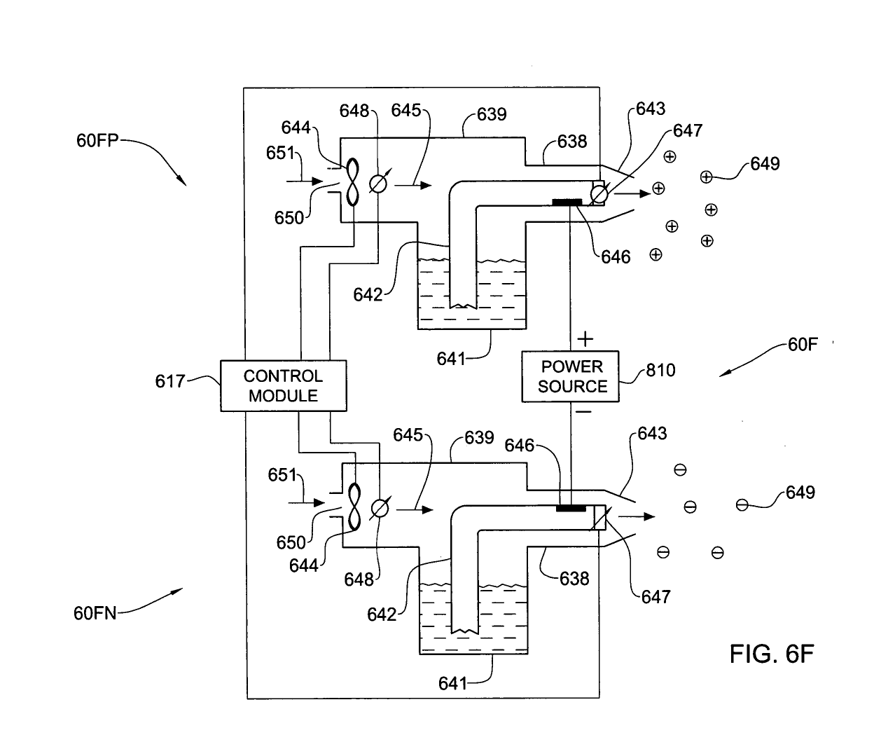

Referring now to FIGS. 6A-6G, there are illustrated various embodiments of an apparatus for controlling atmospheric conditions in a portion 66 of the atmosphere. It should be noted that the blocks in FIGS. 6A-6G are intended as functional entities only, such that the functional relationships between the entities are shown, rather than any physical connections and/or physical relationships.

FIG. 6A is a schematic block diagram of an apparatus 60A for controlling atmospheric conditions, according to one embodiment of the present invention. The apparatus 60A includes a chamber 61 for providing an element flow stream 63, a charger 62 coupled to the chamber 61 for charging seeding elements 64 in an element flow stream 63, a seeder 65 for releasing a charged element flow stream 70 and controllably scattering charged seeding elements 71 of the charged element flow stream 70 in a portion 66 of the atmosphere, and a control module 67 for controlling the operation of the apparatus 60A.

The chamber 61 of the apparatus includes a feeder 620 for allowing the introduction of raw material (not shown) into the chamber 61, a mixer 610 for mixing an air flow stream 68 with a particulate material derived from the raw material and an outlet 72 for releasing the particulate seeding elements 64 obtained thereby to the charger 62. The air flow stream 68 may be provided by a fan 625 arranged in the mixer 610.

In order to control the operation of the apparatus, the control module 67 of the apparatus 60A is equipped with various known devices for indicating and regulating certain parameters such as the amount and kind of the raw material to be used, the strain of the air in the air flow stream 68, the strain of the element flow stream 63, the strain of the charged element flow stream 70, the size, charge and concentration of the charged seeding elements 71 in the charged element flow stream 70, etc.

Accordingly, the control module of the apparatus can include a first strain regulator 81 arranged in the mixer 610 for producing a first sensor signal representative of the strain of the air in the air flow stream 68. The control module 67 is responsive to the first sensor signal for controlling the strain. The control module 67 can also include a second strain regulator 82 arranged in the outlet 72 for producing a second sensor signal representative of the strain of the element flow stream. The control module is responsive to the second sensor signal for controlling the strain. Further, the module can also include a third strain regulator 83 arranged in the seeder 65 for producing a third sensor signal representative of the strain of the charged element flow stream 70. The control module 67 is responsive to the third sensor signal for controlling the strain.

The control module 67 can include a charge regulator 84 coupled to the charger 62. The regulator is responsive to a signal produced thereby for controlling the charge magnitude and/or polarity of the charged seeding elements. According to the invention, the desired values of the charge of the seeding elements depends on the size distribution of the droplets in the atmosphere, and are calculated by using the collision model (as described above) that describes the collisions between the charged seeding elements and the atmospheric water droplets.

The apparatus 60A can also include a burner 630 coupled to the chamber 61 for burning the raw material so as to form the particulate material as a combustion product. In such a case, the control module 67 can include a temperature regulator 85 coupled to the burner 630. The temperature regulator is responsive to a temperature signal produced thereby for controlling the temperature in the burner 630.

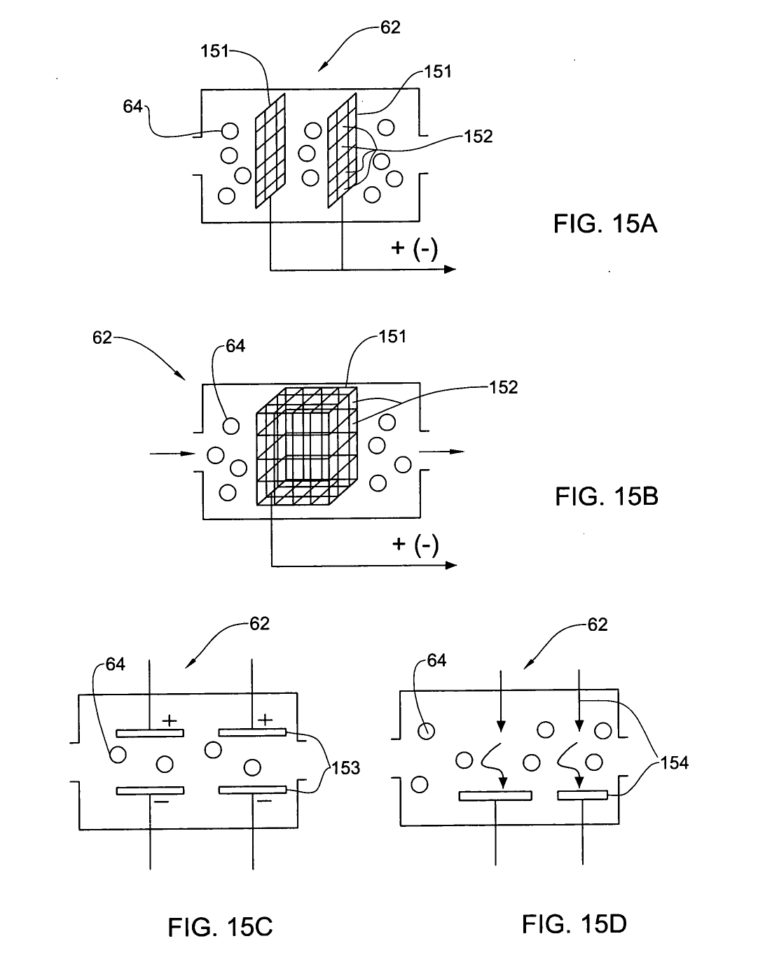

Referring to FIGS. 15A-15D, schematic views of exemplary configurations of electrodes that can be used with the charger 62 are illustrated.

According to the examples shown in FIGS. 15A-15B, the charger 62 includes one or more unipolar electrodes 151 capable to produce an electric field, when the electrode(s) is/are charged either positively or negatively. The particular seeding elements 64 can be electrically charged when they are passed through the electric field or brought into contact with the electrodes 151. Likewise, the particular seeding elements 64 can be electrically charged owing to an electric discharge (e.g., corona discharge) between the elements and the electrodes.

According to the example shown in FIG. 15A, each unipolar electrode 151 can be configured in the form of one or more two-dimensional grids with a controllable size of its cells 152. According to the example shown in FIG. 15B, each unipolar electrode 151 can be configured in the form of one or more three-dimensional grids with a controllable size of its cells 152.

The elements 64 can pass either through the grid cells without a contact or with a contact to the grid's frame. A control of the charging of the elements 64 can, for example, be provided by means of altering a magnitude of electric potential applied to the grid electrode and/or by changing the dimension of the grid cells.

According to the example shown in FIG. 15C, the charger 62 includes one or more pairs of bipolar electrodes 153 configured for producing an electric field therebetween. The particular seeding elements 64 can be electrically charged when they are passed between the electrodes through the electric field and/or or brought in contact with the electrodes 153.

According to the example shown in FIG. 15D, the charger 62 includes one or more pairs of electrodes 154 configured for producing an electric discharge. The particular seeding elements 64 can be electrically charged when they are passed through the electric discharge.

Turning back to FIG. 6A, the apparatus 60A receives electric power from an electrical power source 80 coupled to the chamber 61, charger 62, seeder 65 and their components for providing electrical power for operation of the apparatus.

Referring to FIG. 6B, a schematic block diagram of an apparatus 60B for controlling atmospheric conditions in the atmosphere is illustrated, according to another embodiment of the invention. The apparatus 60B distinguishes from the apparatus 60A in that the chamber 61 does not include the feeder and the burner of the particulate material.

In operation, the air flow stream 680 is provided by an inlet 621 arranged in the arranged in the mixer 610. The inlet 621 is fitted for receiving an input air flow stream 69 containing atmospheric water droplets 622 and transferring this stream to the chamber 61, thereby providing an air flow stream 680 containing the water droplets. The air flow stream 680 can be fed to the charger 62 coupled to the chamber 61 for charging the water droplets. According to this embodiment, the seeding elements are charged water droplets. The operation of all the other elements of the apparatus 60B is similar to those of the apparatus 60A.

It should be appreciated that the apparatus 60B can also include a suction device 690, such as a pump, arranged in the inlet 621 for the facilitation of the receiving of the input air flow stream 69.

According to yet another embodiment of the invention, the charged seeding elements contain the charged particles together with the charged atmospheric water droplets. In this case, the apparatus of the present invention can include two chambers identified by reference numeral 61 in FIG. 6A and FIG. 6B. One of these chambers can provide a first element flow stream containing particles of a particulate material, as described above with reference to FIG. 6A, while the other chamber can provide a second element flow stream containing atmospheric water droplets, as descried above with reference to FIG. 6B. A combined element flow stream provided by these two chambers, that includes both particles and water droplets, can be fed to the charger 62, and further to the seeder 65, as described above.

Referring now to FIG. 6C, there is illustrated a schematic block diagram of an apparatus 60C for controlling atmospheric conditions in the portion 66 of the atmosphere, according to a further embodiment of the present invention. The apparatus 60C includes two substantially identical apparatus portions 60CP and 60CN for controllable producing positively and negatively charged seeding elements, respectively. The apparatus 60C further includes a power source 800 and a control module 607 for controlling the operation of the apparatus 60C. The controllable producing implies providing required concentration of charged elements of each polarity. It should be noted that the concentration and charge value of the positively charged elements may be equal to or different from the concentration and charge value of the negatively charged elements. According to the invention, the optimal values of the concentration and the charge of the seeding elements are calculated as described above by using a collision model describing collisions between the charged seeding elements and the atmospheric water droplets.

Since the configuration and operation of the apparatus portions 60CP and 60CN are similar, only one of such portions (i.e., the apparatus portion 60CP) will be described hereinbelow in detail.

The apparatus portion 60CP includes a chamber 601 for providing an element flow stream 603, a charger 602 coupled to the chamber 601 for charging the elements 64 in the element flow stream 603, a seeder 605 for releasing a charged element flow stream 700 and controllably scattering charged elements 71 (e.g., charged water droplets) of the charged element flow stream 700 in the portion 66 of the atmosphere.

The chamber 601 of the apparatus includes an inlet 721 for receiving an input air flow stream 609 containing atmospheric water droplets 622 and transferring this stream to the chamber 601, thereby providing element flow stream 603 within the chamber 601 containing the water droplets. The element flow stream 603 is fed to the charger 602 coupled to the chamber 601 via an outlet 722 for charging the water droplets. When required, the apparatus portion 60CP can include a fan 631 arranged in the chamber 601 and coupled to the control module for controllable enhancing the element flow stream 603.

When required, each of the portions of the apparatus 60C can also include a suction device 690, such as a pump, arranged in the inlet 721 for the facilitation of the receiving of the input air flow stream 609.

When required, each of the portions of the apparatus 60C can also include a feeder 620 for allowing the introduction of raw material into the chamber 601. Examples of the raw material include, but are not limited to various commercially produced flares such as French flare, Newai flare, D383 flare, Sanormal flare, etc. The air flow stream 603 is mixed with a particulate material derived from the raw material and fed to the charger 602 via the outlet 722.

When required, each of the portions of the apparatus 60C can also include a burner 630 coupled to the chamber 601 for burning the raw material so as to form the particulate material as a combustion product. In such a case, the control module 607 can include a temperature regulator 632 coupled to the burner 630. The temperature regulator 632 is responsive to a temperature signal produced thereby for controlling the temperature in the burner 630.

Exemplary configurations of the electrodes that can be used in the charger 602 are shown in FIGS. 15A and 15B. The operation of the charger 602 is similar to the operation of charger 62 in FIGS. 6A and 6B, described above.

Referring now to FIG. 6D, there is illustrated a schematic block diagram of an apparatus 60D for controlling atmospheric conditions in the portion 66 of the atmosphere, according to still a further embodiment of the present invention. The apparatus 60D is similar to the apparatus (60C in FIG. 6C) in the fact that it also includes two substantially identical apparatus portions 60DP and 60DN for controllable producing positively and negatively charged seeding elements, a power source 810, and a control module 617 for controlling the operation of the apparatus. The controllable producing also implies providing required concentration of charged elements of each polarity. The optimal values of the concentration and the charge of the seeding elements depend on the size distribution of the droplets in the atmosphere, and are calculated by using the collision model, as described above.

Each of the apparatus portions 60DP and 60DN includes a chamber 611, a charger 612, and a seeder 615. The apparatus 60D distinguishes from the apparatus 60C in the fact that the apparatus portions 60DP and 60DN further include a feeder 720 of uncharged water droplets coupled to the chamber 611.

According to one embodiment of the invention, the feeder 720 includes a tank containing water 721 (used as a raw material), and a droplet maker 722. The droplet maker 722 can, for example, be an ultrasonic mist generator capable of producing discreet droplets of desired size. As described above, the droplet size effects the collision efficiency. Thus, the controllable producing of charged elements further implies providing the charged water droplets of desired size. The control of the droplet size can be achieved by varying operating ultrasonic frequency. The droplet maker 722 is coupled to the control module 617. The droplet maker 722 is responsive to a droplet size signal produced by the control module 617.

The chamber 611 of each of the apparatus portions 60DP and 60DN includes a fan 616 enabled and positioned for providing an element flow stream 618, driving the uncharged water droplets (i.e., elements 625) produced by the droplet maker 722 in the charger 612 configured for controllably charging the droplets, as described above. After charging, a charged element stream 619 is controllably released in the atmosphere by the seeder 615. It should be appreciated that when required, the chamber 611 may include an inlet 623 for receiving an input air flow stream 624 and providing the element flow stream 618 instead of or together with the fan 616.

According to embodiment of the invention, the chamber 611 can further include a water collection section 656 for collecting and precipitating atmospheric droplets from the input air flow stream 624, and thereby compensating for the water 721 taken from the tank of the feeder 720. The collection section 656 is in communication with the feeder 720 via a manifold 657. The collection section 656 can, for example, include a rotor 658 arranged for displacing the atmospheric water droplets to walls of the collection section 656. According to this embodiment, the displaced droplets can be absorbed on the walls of the collection section 656, and thereafter the collected water can be discharged from the walls into the feeder 720 through the manifold 657.

It should be noted that each of the apparatus portions 60DP and 60DN can include a strain regulator 620 electrically coupled to the fan 616 and controlled by control module 617 for regulating the stream 618 of the uncharged elements 625, as described above in connection with the embodiment shown in FIG. 6C. Likewise, each of the apparatus portions 60DP and 60DN includes a strain regulator 621 arranged in the seeder 615 for producing a sensor signal representative of the strain of the stream 618. The control module 617 is responsive to this sensor signal for controlling the strain of the stream 618, and consequently, regulating also the streams 619 of the charged elements 626.

Referring now to FIG. 6E, there is illustrated a schematic block diagram of an apparatus 60E for controlling atmospheric conditions in the portion 66 of the atmosphere, according to yet another embodiment of the present invention. The apparatus 60E includes two substantially identical apparatus portions 60EP and 60EN for controllable producing positively and negatively charged seeding elements, a power source 810, and the control module 617 for controlling the operation of the apparatus.

Each of the apparatus portions 60EP and 60EN includes a seeder 628 and a chamber 670 associated with a charger, thereby it combines the functions of the chamber and charger of the apparatus shown in FIGS. 6C and 6D. The chamber 670 includes a feeder 730 that comprises a tank containing water 721, and the droplet maker 722. According to this embodiment of the invention, the power source 810 is coupled directly to the water 721 for providing an electric potential thereto, for example, via an electrode 723.

In such a case, the droplet maker 722 arranged in each of the apparatus portions 60EP and 60EN is capable of producing discreet droplets 732 and 733 charged positively and negatively, respectively Each of the apparatus portions 60EP and 60EN can include a fan 671 enabled and positioned for driving the charged water droplets 732 and 733 produced by the droplet makers 722 in the atmosphere. It should be appreciated that when required, the chamber 670 may include an inlet 633 for receiving an input air flow stream 634 and providing the element flow stream 618 instead of or together with the fan 671. Likewise, the chamber 670 can further include a water collection section (not shown in FIG. 6E) arranged for collecting and precipitating atmospheric droplets, and thereby compensating for water 721, as described above with reference to FIG. 6D.

The control module 617 is configured to be responsive to signals produced by the power source 810, the droplet maker 722, the fan 671 and the strain regulators 620 and 621 for control of the working parameters of the apparatus, as described above with reference to FIGS. 6A-6D.

Referring now to FIG. 6F, there is illustrated a schematic block diagram of the apparatus of the present invention for controlling atmospheric conditions in the portion of the atmosphere, according to yet another embodiment of the present invention. The apparatus (indicated by a reference numeral 60F) includes two substantially identical apparatus portions 60FP and 60FN for controllable producing positively and negatively charged seeding elements, a power source 810, and the control module 617 for controlling the operation of the apparatus.

Each of the apparatus portions 60FP and 60FN represents a spraying device including a chamber 639 and a seeder 638. The chamber 639 includes a feeder 641 containing water (or other suitable liquid), a manifold 642 configured for providing the water to a spray nozzle 643 of the seeder 638. The chamber can include a fan 644 providing an air stream 645 sufficient for spraying the water from the nozzle 643 in the form of water droplets 649. The manifold 642 includes an electrode 646 coupled to the power source 810 for charging the water passing therethrough with the desired electric potential. The nozzle 643 includes an orifice regulator 647 arranged at the nozzle orifice for producing an orifice dimension signal representative of the orifice dimension. The control module 617 is responsive to this signal for varying the orifice dimension. This feature enables controlling the droplet size which depends on the orifice dimension. Each of the apparatus portions 60FP and 60FN further includes a strain regulator 648 electrically coupled to the fan 644 and controlled by control module 617 for regulating velocity of the air stream 645. The operation of the strain regulator 648 is similar to the equivalent device described above with reference to FIGS. 6A-6E.

It should be appreciated that when required, the chamber 639 may include an inlet 650 for receiving an input air flow stream 651 and providing the air flow stream 645 instead of or together with the fan 644.

According to the invention, the desired values of the sizes of the water droplets, the charges and polarity of the droplet as well as the concentration of the droplets in the atmosphere are calculated by using the collision model, as described above. This model enables to find optimal values for these parameters, depending on the size distribution of the atmospheric droplets.

According to one embodiment of the invention, controlling the atmospheric conditions for the purpose of rain regulation by seeding electrically charged particles in clouds can be carried out by the apparatus that is mounted on a flying object, e.g., an airplane, helicopter or dirigible. For the controllable dispersal of fog or ground mist, the apparatus can be carried on a motorized vehicle. Likewise, the water droplets of fog can be treated by a low flying airplane controllably dispersing the electrically charged particles in accordance with the invention.

According to another embodiment of the invention, the control of the atmospheric conditions can be effected from a ground located source, e.g. from a chimney-stack. In this case, the charger, of the kind described above, can be mounted within the chimney-stack in order to charge the smoke particles ejected into the atmosphere when clouds or fog are in the vicinity of the chimney-stack. The controllable scattering of the charged smoke particles not only affects the atmospheric conditions, but can also scavenge the atmosphere from the ejected materials.

Use of the method and apparatus according to the invention may result in a higher precipitation of rain than hitherto-proposed techniques and rain produced using the method and apparatus according to the invention falls within the scope of the invention as defined by the appended claims.

As such, those skilled in the art to which the present invention pertains, can appreciate that while the present invention has been described in terms of preferred embodiments, the concept upon which this disclosure is based may readily be utilized as a basis for the designing of other structures, systems and processes for carrying out the several purposes of the present invention.

It is apparent that although the examples based on the numerical experiments were shown for interaction between the neutral drop and electrically charged droplets (particles), the method of the present invention can be applied for controlling the collision rate between the charged drops and neutral droplets (particles), or charged drops and charged droplets (particles).

Moreover, any reference to a specific implementation in terms of usage of the chamber, the charger, the control module, or any other components are shown by way of a non-limiting example.

Also, it is to be understood that the phraseology and terminology employed herein are for the purpose of description and should not be regarded as limiting.

In the method claims that follow, alphabetic characters used to designate claim steps are provided for convenience only and do not imply any particular order of performing the steps.

Finally, it should be noted that the word “comprising” as used throughout the appended claims is to be interpreted to mean “including but not limited to”.

It is important, therefore, that the scope of the invention is not construed as being limited by the illustrative embodiments set forth herein. Other variations are possible within the scope of the present invention as defined in the appended claims and their equivalents.

1. A method of controlling atmospheric conditions in a portion of the atmosphere containing microscopic water droplets dispersed therein so as to produce their desired coalescence and precipitation, the method includes:
(a) determining a size distribution of water droplets in said portion of the atmosphere;
(b) providing a predetermined amount of a seeding material having uncharged seeding elements of a predetermined size distribution;
(c) electrically charging the uncharged seeding elements so as to produce charged seeding elements having a predetermined polarity and charge magnitude, said predetermined polarity and charge magnitude being calculated by using a collision model describing collisions between said charged seeding elements and said microscopic water droplets; and
(d) seeding said charged seeding elements in said portion of the atmosphere.

2. The method of claim 1 wherein said portion of the atmosphere is a portion of cloud.

3. The method of claim 1 wherein said portion of the atmosphere is a portion of fog.

4. The method of claim 1 wherein the water droplets are substantially electrically neutral.

5. The method of claim 1 wherein the water droplets are electrically charged.

6. The method of claim 1 wherein the calculation of the polarity and charge magnitude of the seeding elements takes into account said size distribution of the water droplets in said portion of the atmosphere.

7. The method of claim 3 wherein said seeding elements are charged with opposite polarity charges.

8. The method of claim 2 wherein said seeding elements are charged with the same polarity charges.

9. The method of claim 1 wherein said seeding material includes particles of a particulate material.

10. The method of claim 1 wherein said seeding material includes atmospheric water droplets.

11. The method of claim 9 wherein the providing of the particulate material includes burning a pyrotechnic material.

12. The method of claim 9 wherein the particles are soot particles.

13. The method of claim 9 wherein the particulate material is a powdered solid material.

14. The method of claim 1 wherein a size of said seeding elements ranges from 0.1 micron to 20 microns.

15. The method of claim 1 wherein the charge magnitude of the charged seeding elements ranges from about ±10⁻¹⁶ Coulomb to about ±10⁻¹² Coulomb.

16. The method of claim 1 wherein said electrically charging of the seeding elements comprising passing the particles through an electric discharge of a predetermined discharge characteristic.

17. The method of claim 16 wherein said electric discharge is corona discharge.

18. The method of claim 1 wherein said electrically charging of the seeding elements comprising bringing said seeding elements into contact with charged electrodes.

19. The method of claim 18 wherein said charged electrodes are grid electrodes.

20. The method of claim 1 wherein the controlling of the atmospheric conditions is effected from a flying object.

21. The method of claim 1 wherein the controlling of the atmospheric conditions is effected from a ground located source.

22. The method of claim 21 wherein the ground located source is a chimney stack.

23. A method of controlling atmospheric conditions in a portion of the atmosphere containing microscopic water droplets so as to cause their coalescence and precipitation, the method characterized by:
adjusting non-gravitational attraction forces between the droplets to a predetermined value so as to alter an effective collision rate between the water droplets, where said adjusting of the non-gravitational attraction forces includes:
(a) determining a size distribution of water droplets in said portion of the atmosphere;
(b) providing a predetermined amount of a seeding material having uncharged seeding elements of a predetermined size distribution;
(c) electrically charging the uncharged seeding elements so as to produce charged seeding elements having a predetermined polarity and charge magnitude, said predetermined polarity and charge magnitude being calculated by using a collision model describing collisions between said charged seeding elements and said microscopic water droplets; and
(d) seeding said charged seeding elements in said portion of the atmosphere.

24. The method of claim 23 wherein said portion of the atmosphere is a portion of cloud.

25. The method of claim 23 wherein said portion of the atmosphere is a portion of fog.

26. The method of claim 23 wherein said droplets are substantially electrically neutral.

27. The method of claim 23 wherein said droplets are electrically charged.

28. A method of claim 23 wherein the calculation of the polarity and charge magnitude of the seeding elements takes into account said size distribution of the water droplets in said portion of the atmosphere.

29. The method of claim 25 wherein said seeding elements are charged with opposite polarity charges.

30. The method of claim 24 wherein said seeding elements are charged with the same polarity charges.

31. The method of claim 23 wherein said seeding material includes particles of a particulate material.

32. The method of claim 23 wherein said seeding material includes atmospheric water droplets.

33. The method of claim 31 wherein the providing of the particulate material includes burning a pyrotechnic material.

34. The method of claim 31 wherein the particles are soot particles.

35. The method of claim 31 wherein said particulate material is a powdered solid material.

36. The method of claim 23 wherein the seeding elements have a spread of sizes ranging from sub-micron to several micron sizes.

37. The method of claim 23 wherein the charge magnitude of the charged seeding elements ranges from about ±10⁻¹⁶ Coulomb to about ±10⁻¹² Coulomb.

38. The method of claim 23 wherein said electrically charging of the seeding elements comprising passing the particles through an electric discharge of a predetermined discharge characteristic.

39. The method of claim 38 wherein said electric discharge is corona discharge.

40. The method of claim 23 wherein said electrically charging of the seeding elements comprising bringing said seeding elements into contact with charged electrodes.

41. The method of claim 23 said effective collision rate is proportional at least to a collision efficiency and a concentration of the droplets.

42. The method of claim 41 wherein said collision efficiency has a value higher than 1.

43. The method of claim 41 wherein said collision efficiency ranges from 0.001 to 1000.

44. The method of claim 23 wherein the controlling of the atmospheric conditions is effected from a flying object.

45. The method of claim 23 wherein the controlling of the atmospheric conditions is effected from a ground located source.

46. The method of claim 45 wherein said ground located source is a chimney stack.

47. An apparatus for controlling atmospheric conditions in a portion of the atmosphere containing microscopic water droplets dispersed therein, the apparatus comprising:
(a) at least one apparatus portion for controllable producing unipolar charged seeding elements, each apparatus portion comprising:
(i) a chamber for providing an element flow stream of a seeding material containing uncharged seeding elements having a predetermined size;
(ii) a charger downstream of the chamber and in communication therewith for charging said uncharged seeding elements in said element flow stream so as to produce charged seeding elements having a predetermined polarity and charge magnitude;
(iii) a seeder for controllable scattering said charged seeding elements in said portion of the atmosphere,
(b) an electrical power source for providing electrical power required for operation of the apparatus, and
(c) a control module for controlling operation of the apparatus on the basis of a collision model describing collisions between said charged seeding elements and said microscopic water droplets.

48. The apparatus of claim 47 comprising two apparatus portion for controllable producing positively and negatively charged seeding elements, respectively.

49. The apparatus of claim 47 wherein said seeding material includes particles of a particulate material.

50. The apparatus of claim 49 wherein the chamber comprises a feeder for providing a predetermined amount of the particulate material derived from a required kind of a raw material.

51. The apparatus of claim 50 wherein said chamber includes a fan for providing an air flow stream for mixing with said particulate material, thereby producing an element flow stream.

52. The apparatus of claim 50 further comprising a burner coupled to the chamber for burning said raw material so as to form the particulate material as a combustion product.

53. The apparatus of claim 52 wherein said combustion product is soot particles.

54. The apparatus of claim 47 wherein said seeding material includes atmospheric water droplets.

55. The apparatus of claim 54 wherein said chamber includes an inlet for receiving an input air flow stream from atmosphere and transferring the input air flow stream comprising the atmospheric water droplets to the chamber, thereby providing an element flow stream.

56. The apparatus of claim 55 further including a suction device arranged in said inlet.

57. The apparatus of claim 48 wherein the chamber of each apparatus portion includes a feeder containing water and a manifold configured for providing the water to a spray nozzle for creating water droplets.

58. The apparatus of claim 57 wherein said manifold includes an electrode coupled to the power source for charging the water passing therethrough with the desired electric potential, thereby creating charged water droplets.

59. The apparatus of claim 48 wherein the chamber of each apparatus portion further comprises a feeder containing water as a raw material.

60. The apparatus of claim 59 wherein said feeder includes droplet maker configured for making water droplets of desired size.

61. The apparatus of claim 60 wherein the droplet maker is an ultrasonic mist generator.

62. The apparatus of claim 59 wherein the chamber further comprises a water collection section for collecting and precipitating atmospheric droplets from said input air flow stream, where said collection section includes a rotor arranged for displacing the atmospheric water droplets to the walls of the collecting section.

63. The apparatus of claim 59 wherein said water is coupled to said electrical power source via an electrode for providing an electric potential thereto.

64. The apparatus of claim 47 wherein said portion of the atmosphere is a portion of cloud.

65. The apparatus of claim 47 wherein said portion of the atmosphere is a portion of fog.

66. The apparatus of claim 47 wherein said droplets are substantially electrically neutral.

67. The apparatus of claim 49 wherein the particulate material is a powder.

68. The apparatus of claim 47 wherein the seeding elements have a spread of sizes ranging from sub-micron to several micron sizes.

69. The apparatus of claim 47 wherein the value of the charge of the seeding elements ranging from about ±10⁻¹⁶ Coulomb to about ±10⁻¹² Coulomb.

70. The apparatus of claim 47 wherein the charger comprises at least one electrode for producing an electric field.

71. The apparatus of claim 70 wherein said at least one electrode is configured in a form of at least one grid.

72. The apparatus of claim 71 wherein the grid is selected from two-dimensional and three-dimensional grids.

73. The apparatus of claim 47 wherein the charger comprises at least one electrode for producing an electric discharge.

74. The apparatus of claim 55 wherein said control module includes a first strain regulator arranged in the inlet for producing a first sensor signal representative of a strain of the air in the air flow stream, the control module being responsive to said first sensor signal for controlling the strain.

75. The apparatus of claim 47 wherein said control module includes a second strain regulator arranged in the outlet for producing a second sensor signal representative of a strain of the element flow stream, the control module being responsive to said second sensor signal for controlling the strain.

76. The apparatus of claim 47 wherein said control module includes a third strain regulator arranged in the seeder for producing a third sensor signal representative of a strain of the charged element flow stream, the control module being responsive to said third sensor signal for controlling the strain.

77. The apparatus of claim 52 wherein said control module includes a temperature regulator arranged in the chamber and is responsive to a signal produced thereby for controlling temperature in the burner.

78. The apparatus of claim 47 wherein said control module includes a charge regulator arranged in the charger and is responsive to a signal produced thereby for controlling the charge magnitude and/or polarity of the charged particles.

79. The apparatus of claim 60 wherein said control module is coupled to said droplet maker responsive to a droplet size signal produced by the control module for controlling the size of said water droplets.

80. The apparatus of claim 47 for use with a flying object.

81. The apparatus of claim 47 for use with a ground located source.

82. The apparatus of claim 81 wherein said ground located source is a chimney-stalk.

83. Rain obtainable by the method of claim 1.

84. Rain obtainable by the method of claim 23.
